(19) United States
(12) Patent Application Publication
(10) Pub. No.: US 2012/0236931 A1
(43) Pub. Date: Sep. 20, 2012

(54) TRANSFORM COEFFICIENT SCAN

(75) Inventors: Marta Karczewicz, San Diego, CA (US); Xianglin Wang, San Diego, CA (US)

(73) Assignee: QUALCOMM INCORPORATED, San Diego, CA (US)

(21) Appl. No.: 13/333,818

(22) Filed: Dec. 21, 2011

Related U.S. Application Data
(60) Provisional application No. 61/427,058, filed on Dec. 23, 2010.
(60) Provisional application No. 61/449,651, filed on Mar. 5, 2011.
(60) Provisional application No. 61/450,081, filed on Mar. 7, 2011.

(51) Int. Cl. H04N 7/30

(52) U.S. Cl. 375/240.02; 375/E07.229

(57) ABSTRACT

This disclosure describes techniques for coding transform coefficients for a block of video data. According to these techniques, a video encoder may adaptively scan a first plurality of coefficients of a two-dimensional matrix of coefficients, and use a fixed scan technique for a second plurality of coefficients of the two-dimensional matrix, to generate a one-dimensional vector of transform coefficients. Also according to these techniques, a video decoder may adaptively scan a first plurality of coefficients of a one-dimensional vector of coefficients, and use a fixed scan technique for a second plurality of coefficients of the one-dimensional vector, to generate a two-dimensional matrix of transform coefficients.

This application claims the benefit of U.S. Provisional Application No. 61/427,058 titled “COEFFICIENT CODING WITH VARIABLE LENGTH CODE IN VIDEO CODING” filed Dec. 23, 2010, U.S. Provisional Application No. 61/449,651 titled “COEFFICIENT CODING WITH VARIABLE LENGTH CODE IN VIDEO CODING” filed Mar. 5, 2011, and U.S. Provisional Application No. 61/450,081 titled “COEFFICIENT CODING WITH VARIABLE LENGTH CODE IN VIDEO CODING” filed Mar. 7, 2011, the entire contents of each of which are incorporated herein by reference.

### TECHNICAL FIELD

This disclosure relates to video coding and compression. More specifically, this disclosure is directed to techniques for scanning quantized transform coefficients.

### BACKGROUND

In video coding, to compress an amount of data used to represent video data, a video encoder may entropy encode the video data. According to some aspects of entropy encoding, the video encoder may scan a two-dimensional matrix of transform coefficients that represent pixels of an image, to generate a one-dimensional vector of the transform coefficients. A video decoder may decode the video data. As part of the decoding process, the video decoder may scan the one-dimensional vector of transform coefficients, to reconstruct the two-dimensional matrix of transform coefficients.

### SUMMARY

This disclosure is directed to techniques for scanning transform coefficients of a block of video data. For example, according to the techniques described herein, a video encoder may scan a two-dimensional matrix of transform coefficients that represent pixels of at least one image, to generate a one-dimensional vector of the transform coefficients. According to the techniques described herein, the video encoder may use an adaptive scan for first plurality of the transform coefficients of the video block, and use a fixed scan for a second plurality of transform coefficients of the video block. Also according to the techniques described herein, a video decoder may reconstruct the two-dimensional matrix from the one-dimensional vector, by using an adaptive scan for the first plurality of coefficient, and a fixed scan for the second plurality of coefficient, to reconstruct the two-dimensional matrix from the one-dimensional vector of transform coefficients.

For example, a method for decoding a block of video data is described herein. The method includes assigning a first plurality of transform coefficients of a one-dimensional vector of transform coefficients to positions within a two-dimensional matrix of transform coefficients using an adaptive scan to reconstruct the two-dimensional matrix of transform coefficients from the one-dimensional vector. The method further includes assigning a second plurality of transform coefficients of the one-dimensional vector to positions within the two-dimensional matrix of transform coefficients using a fixed scan to reconstruct the two-dimensional matrix from the one-dimensional vector. The method further includes decoding the two-dimensional matrix of transform coefficients.

According to another example, a video decoding device is described herein. The video decoding device includes a scan module. The scan module is configured to assign a first plurality of transform coefficients of a one-dimensional vector of transform coefficients to positions within a two-dimensional matrix of transform coefficients using an adaptive scan to reconstruct the two-dimensional matrix of transform coefficients from the one-dimensional vector. The scan module is further configured to assign a second plurality of transform coefficients of the one-dimensional vector to positions within the two-dimensional matrix of transform coefficients using a fixed scan to reconstruct the two-dimensional matrix from the one-dimensional vector. The device further includes a video decoder configured to decode the reconstructed two-dimensional matrix of transform coefficients.

According to another example, a computer-readable storage medium is described herein. The computer-readable storage medium stores instructions that, when executed by a computing device, cause the computing device to scan a first plurality of transform coefficients of a one-dimensional vector of transform coefficients using an adaptive scan to reconstruct the two-dimensional matrix of transform coefficients from the one-dimensional vector. The instructions further cause the computing device to scan a second plurality of transform coefficients of the one-dimensional vector using a fixed scan to reconstruct the two-dimensional matrix from the one-dimensional vector. The instructions further cause the computing device to decode the two-dimensional matrix of transform coefficients.

According to another example, a video decoding device is described herein. The device includes means for assigning a first plurality of transform coefficients of a one-dimensional vector of transform coefficients to positions within a two-dimensional matrix of transform coefficients using an adaptive scan to reconstruct the two-dimensional matrix of transform coefficients from the one-dimensional vector. The device further includes means for assigning a second plurality of transform coefficients of the one-dimensional vector using a fixed scan to reconstruct the two-dimensional matrix from the one-dimensional vector. The device further includes means for decoding the two-dimensional matrix of transform coefficients.

According to another example, a method for encoding a block of video data is described herein. The method includes scanning a first plurality of transform coefficients of a two-dimensional matrix of transform coefficients using an adaptive scan to generate a one-dimensional vector of transform coefficients. The method further includes scanning a second plurality of transform coefficients of the two-dimensional matrix using a fixed scan to generate the one-dimensional vector from the two-dimensional matrix. The method further includes outputting the one-dimensional vector of transform coefficients.

According to another example, a video encoding device is described herein. The device includes a scan module configured to: scan a first plurality of transform coefficients of a two-dimensional matrix of transform coefficients using an adaptive scan to generate a one-dimensional vector of transform coefficients. The scan module is further configured to scan a second plurality of transform coefficients of the two-dimensional matrix using a fixed scan to generate the one-dimensional vector from the two-dimensional matrix. The scan module is further configured to output the one-dimensional vector of transform coefficients.

According to another example, a computer-readable storage medium that stores instructions that, when executed by a computing device, cause the computing device to scan a first plurality of transform coefficients of a two-dimensional matrix of transform coefficients using an adaptive scan to generate a one-dimensional vector of transform coefficients. The instructions are further configured to cause the computing device to scan a second plurality of transform coefficients of the two-dimensional matrix using a fixed scan to generate the one-dimensional vector from the two-dimensional matrix. The instructions are further configured to cause the computing device to output the one-dimensional vector of transform coefficients.

According to another example, a video decoding device is described herein. The device includes means for scanning a first plurality of transform coefficients of a two-dimensional matrix of transform coefficients using an adaptive scan to generate a one-dimensional vector of transform coefficients. The device further includes means for scanning a second plurality of transform coefficients of the two-dimensional matrix using a fixed scan to generate the one-dimensional vector from the two-dimensional matrix. The device further includes means for outputting the one-dimensional vector of transform coefficients.

The details of one or more examples are set forth in the accompanying drawings and the description below. Other features, objects, and advantages of the invention will be apparent from the description and drawings, and from the claims.

### BRIEF DESCRIPTION OF DRAWINGS

FIG. 1 is a block diagram that illustrates one example of a video encoding and decoding system configured to operate according to the techniques of this disclosure.

FIG. 2 is a block diagram that illustrates one example of a video encoder configured to operate according to the techniques of this disclosure.

FIG. 3 is a block diagram that illustrates one example of a video decoder configured to operate according to the techniques of this disclosure.

FIGS. 4A-4C are conceptual diagrams that illustrates some examples of predetermined scan patterns that may be used according to the techniques of this disclosure.

FIG. 5 is a conceptual diagram that illustrates one example of a scan that may be performed by an encoder to scan a two-dimensional matrix of transform coefficients to generate a one-dimensional vector of the transform coefficients consistent with the techniques of this disclosure.

FIG. 6 is a conceptual diagram that illustrates one example a scan that may be performed by a decoder to scan a one dimensional vector of transform coefficients to reconstruct a two-dimensional matrix of the transform coefficients consistent with the techniques of this disclosure.

FIG. 7 is a flow diagram that illustrates one example of a method of encoding a block of video data consistent with the techniques of this disclosure.

FIG. 8 is a flow diagram that illustrates one example of a method of decoding a block of video data consistent with the techniques of this disclosure.

FIG. 9 is a conceptual diagram that illustrates one example of a technique for coding a block of video data consistent with the techniques of this disclosure.

### DETAILED DESCRIPTION

In general, this disclosure describes techniques for coding video data. More specifically, this disclosure describes techniques relating to scanning transform coefficients during a video coding process. Encoded video data may include prediction data and residual data. A video encoder may produce the prediction data using an intra-prediction mode or an inter-prediction mode. Intra-prediction generally involves predicting a block of a picture relative to neighboring, previously coded blocks of the same picture. Inter-prediction generally involves predicting a block of a picture relative to data of a previously coded picture.

Following intra- or inter-prediction, a video encoder may calculate a residual value for the block. The residual value generally corresponds to the difference between the predicted data for the block and the true value of the block. To further compress the residual value of a block, the residual value may be transformed into a set of transform coefficients that compact as much data (also referred to as “energy”) as possible into as few coefficients as possible. The transform coefficients correspond to a two-dimensional matrix of coefficients that is the same size as the original block. In other words, there are just as many transform coefficients as pixels in the original block. However, due to the transform, many of the transform coefficients may have values equal to zero.

The video encoder may then quantize the transform coefficients to further compress the video data to reduce the amount of data needed to represent the quantized transform coefficients. Following quantization, the video encoder may scan the transform coefficients, producing a one-dimensional vector from the two-dimensional matrix including the quantized transform coefficients. The video encoder may zero out certain coefficients prior to or following the scan.

The video encoder may then entropy encode the resulting array, to even further compress the data. In some examples, the video encoder may be configured to use variable length codes (VLCs) to represent various possible quantized transform coefficients of the array, e.g., using context-adaptive variable-length coding (CAVLC). In other examples, the video encoder may be configured to use binary arithmetic coding to encode the resulting quantized coefficients, e.g., using context-adaptive binary arithmetic coding (CABAC).

In some examples, a video coder (e.g., encoder, decoder) may be configured to use VLC as a binarization scheme for CABAC to code transform coefficients. For example, a video encoder operating to use CABAC may be configured to use VLC techniques, such as those described herein, to encode the transform coefficients into a stream of binary values. According to these examples, such binary values may then be coded using CABAC. In some examples, using VLC as a binarization scheme for CABAC may generate less binary values (i.e., less bits of data) for a CABAC coder (e.g., encoder, decoder) to code in comparison to other techniques, which may improve the throughput of CABAC coding performed by the coder. In some examples, binarized values generated using VLC as a binarization scheme for CABAC may be coded using a CABAC bypass mode, where each binary value may be assumed to be equally likely to have a value of 0 or 1. In some examples, coding using such a CABAC bypass mode may be simpler than other standard CABAC coding techniques.

In some examples, a video coder as described herein may be configured to transition between using VLC and using other techniques as the binarization process for CABAC. For example, a video coder may be configured to use VLC to binarize some transform coefficients, and use another technique to perform binarization of other coefficients. In some examples, such a video coder may dynamically determine whether to use VLC as the binarization process of CABAC or some other technique, based on one or more characteristics of video data being coded.

According one or more aspects of this disclosure, techniques are described for coding transform coefficients using VLC. Any of these techniques may be used alone to code one or more transform coefficients of video data, or in combination with one or more other techniques for coding transform coefficients of video data, such as CABAC techniques. For example, any of the VLC coding techniques described herein may be used as a binarization scheme for CABAC to code transform coefficients, as described above.

This disclosure provides techniques for scanning, by a video encoder, transform coefficients in order to generate a one-dimensional vector that can then be entropy encoded. In accordance with these techniques, a video encoder may perform an adaptive scan technique to scan a first plurality of transform coefficient of the two-dimensional matrix, and use a fixed scan technique to scan a second plurality of transform coefficients of the block. In this manner, the video encoder may be configured to encode blocks of video data of different sizes, with improved coding efficiency in comparison to other scan techniques.

For example, to scan the first plurality of transform coefficients, the encoder may modify an order in which at least one of the first plurality of transform coefficients at positions within the two-dimensional matrix are scanned to generate the one-dimensional vector, relative to an order for which transform coefficients at the same positions within the two-dimensional matrix were scanned for a least one previously encoded block of video data. For example, the video encoder may store an initial, predetermined scan pattern. As the video encoder encodes blocks of a picture, the video encoder may update the scan pattern adaptively for the first plurality of transform coefficients.

For example, the video encoder may collect statistics indicative of whether coefficients of the first plurality of transform coefficients (e.g., positions of the first plurality of transform coefficients within the two-dimensional matrix) tend to be zero-valued, and if a coefficient at a particular location is commonly zero-valued, the video encoder may elect to scan the zero-valued coefficient later than other coefficients (e.g., coefficient positions) that commonly have non-zero values. In this manner, an order in which the video encoder scans the first plurality of coefficients may be adapted, relative to a scan order for at least one previously encoded block of video data (e.g., relative to an order of an initial, predetermined scan pattern).

According to the adaptive scan of the first plurality of coefficients, the coefficient values of each video block (e.g., whether the coefficients are zero-valued or non-zero valued) may be used to update statistics and the statistics may define the scan order applied to the next video block. In this way, the scan order of the first plurality of coefficients may adapt from block to block, based on the accumulated statistics of previous blocks.

To scan the second plurality of transform coefficients of the two-dimensional matrix, the encoder may use a fixed scan technique. The fixed scan technique used to scan the second plurality of coefficients may comprise, in some examples, the same scan technique as the initial predetermined scan pattern that is adaptively updated based on statistics of the first plurality of coefficients as described above. In other examples, the fixed scan technique used to scan the second plurality of coefficients may comprise a different predetermined scan pattern.

According to a fixed scan technique, the encoder may optionally not use statistics to adapt an order in which the second plurality transform coefficients are scanned, relative to one or more previously encoded blocks. Instead, the encoder may scan coefficients using one or more fixed scan patterns such as a horizontal scan, a vertical scan, a zig-zag scan, an inverse horizontal, vertical, or zig-zag scan, or any combination of such fixed scan techniques or any other fixed scan technique.

This disclosure describes techniques related to scanning transform coefficients during a video coding process. The techniques may be applied by both video encoding and decoding units, including video encoder/decoders (CODECs) and processing units configured to perform video encoding and/or decoding. References to “video coding units” or “video coding devices” should be understood to refer to units or devices capable of encoding, decoding, or both encoding and decoding video data.

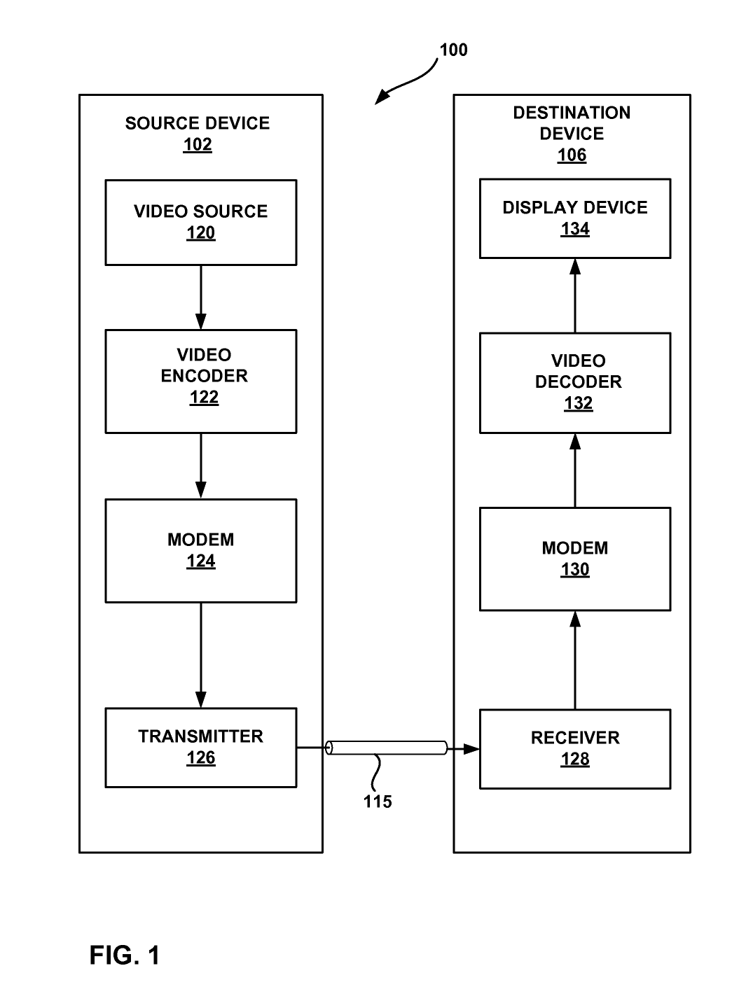

FIG. 1 is a block diagram illustrating an exemplary video encoding and decoding system 100 that may implement techniques of this disclosure. As shown in FIG. 1, system 100 includes a source device 102 that transmits encoded video to a destination device 106 via a communication channel 115. Source device 102 and destination device 106 may comprise any of a wide range of devices. In some cases, source device 102 and destination device 106 may comprise wireless communication device handsets, such as so-called cellular or satellite radiotelephones. The techniques of this disclosure, however, which apply generally to the encoding and decoding transform coefficients of video data, are not necessarily limited to wireless applications or settings, and may be applied to a wide variety of non-wireless devices that include video encoding and/or decoding capabilities.

In the example of FIG. 1, source device 102 may include a video source 120, a video encoder 122, a modulator/demodulator (modem) 124 and a transmitter 126. Destination device 106 may include a receiver 128, a modem 130, a video decoder 132, and a display device 134. In accordance with this disclosure, video encoder 122 of source device 102 may scan transform coefficients of a block of video data that includes a two-dimensional matrix of transform coefficients (e.g., that each correspond to pixels of a displayed image) into a one-dimensional vector that represents the transform coefficients. According to the techniques described herein, video encoder 122 may adaptively scan a first plurality of the coefficients of the block of video data, and use a fixed scan for a second plurality of coefficients of the block. For example, for the first plurality of transform coefficients, video encoder 122 may adaptively modify an order in which the first plurality of transform coefficients are scanned, relative to an order in which transform coefficients of at least one previously encoded block of video data were scanned. For example, video encoder 122 may modify the order in which transform coefficients are scanned, based on a how often coefficients at the same position in other previously encoded blocks are non-zero coefficients. For the second plurality of transform coefficients, video encoder 122 may optionally not adaptively modify an order in which the second plurality of transform coefficients are scanned, relative to a scan order of at least one previously encoded block of video data. Instead, video encoder 122 may scan the second plurality of coefficients using a same scan order, for a plurality of blocks of video data encoded by the encoder.

Reciprocal transform coefficient decoding may also be performed by video decoder 132 of destination device 106. That is, video decoder 132 may map coefficients of a one-dimensional vector of transform coefficients that represent a block of video data to positions within a two-dimensional matrix of transform coefficients, to reconstruct the two-dimensional matrix of transform coefficients. According to the technique described herein, video decoder 132 may perform such mapping based on an adaptive scan order for a first plurality of the coefficients of the one-dimensional vector to generate the two-dimensional matrix, and use a fixed scan to perform such a mapping for a second plurality of the coefficients of the one-dimensional vector.

For example, for the first plurality of transform coefficients, video decoder 132 may adaptively modify a scan order according to which transform coefficients are read from the one-dimensional vector and are assigned to locations in the two-dimensional matrix, to a scan order in which transform coefficients of at least one previously encoded block of video data were assigned to locations in the two-dimensional matrix. For example, video decoder 132 may modify the scan order according to which the first plurality of transform coefficients of the vector are assigned to the two-dimensional matrix, based how often the respective coefficients are non-zero. For the second plurality of transform coefficients, video decoder 132 may optionally not adaptively modify a scan order according to which the second plurality of transform coefficients of the vector are assigned to locations of in the two-dimensional matrix, relative to a scan order of at least one previously encoded block of video data. Instead, video decoder 132 may use a fixed scan, where an order according to which the second plurality of transform coefficients are assigned to locations of the two-dimensional matrix is not adapted based on statistics. In this manner, using such a fixed scan, video decoder 132 may use a same scan order for the second plurality of coefficients of the block, for each of a plurality of blocks (i.e. one-dimensional vectors representing the respective blocks) of video data decoded by the decoder 132.

The illustrated system 100 of FIG. 1 is merely exemplary. The transform coefficient encoding and decoding techniques of this disclosure may be performed by any encoding or decoding devices. Source device 102 and destination device 106 are merely examples of coding devices that can support such techniques.

Video encoder 122 of source device 102 may encode video data received from video source 120. Video source 120 may comprise a video capture device, such as a video camera, a video archive containing previously captured video, or a video feed from a video content provider. As a further alternative, video source 120 may generate computer graphics-based data as the source video, or a combination of live video, archived video, and computer-generated video. In some cases, if video source 120 is a video camera, source device 102 and destination device 106 may form so-called camera phones or video phones. In each case, the captured, pre-captured or computer-generated video may be encoded by video encoder 122.

In system 100, once the video data is encoded by video encoder 122, the encoded video information may then be modulated by modem 124 according to a communication standard, e.g., such as code division multiple access (CDMA) or any other communication standard or technique, and transmitted to destination device 106 via transmitter 126. Modem 124 may include various mixers, filters, amplifiers or other components designed for signal modulation. Transmitter 126 may include circuits designed for transmitting data, including amplifiers, filters, and one or more antennas. Receiver 128 of destination device 106 receives information over channel 115, and modem 130 demodulates the information. Again, the video decoding process performed by video decoder 132 may include similar (e.g., reciprocal) decoding techniques to the encoding techniques performed by video encoder 122.

Communication channel 115 may comprise any wireless or wired communication medium, such as a radio frequency (RF) spectrum or one or more physical transmission lines, or any combination of wireless and wired media. Communication channel 115 may form part of a packet-based network, such as a local area network, a wide-area network, or a global network such as the Internet. Communication channel 115 generally represents any suitable communication medium, or a collection of different communication media, for transmitting video data from source device 102 to destination device 106.

Although not shown in FIG. 1, in some aspects, video encoder 122 and video decoder 132 may each be integrated with an audio encoder and decoder, and may include appropriate MUX-DEMUX units, or other hardware and software, to handle encoding of both audio and video in a common data stream or separate data streams. If applicable, MUX-DEMUX units may conform to the ITU H.223 multiplexer protocol, or other protocols such as the user datagram protocol (UDP).

Video encoder 122 and video decoder 132 each may be implemented as one or more microprocessors, digital signal processors (DSPs), application specific integrated circuits (ASICs), field programmable gate arrays (FPGAs), discrete logic, software, hardware, firmware or any combinations thereof. Each of video encoder 122 and video decoder 132 may be included in one or more encoders or decoders, either of which may be integrated as part of a combined encoder/decoder (CODEC) in a respective mobile device, subscriber device, broadcast device, server, or the like.

In some cases, devices 102, 106 may operate in a substantially symmetrical manner. For example, each of devices 102, 106 may include video encoding and decoding components. Hence, system 100 may support one-way or two-way video transmission between video devices 102, 106, e.g., for video streaming, video playback, video broadcasting, or video telephony.

During the encoding process, video encoder 122 may execute a number of coding techniques or operations. In general, video encoder 122 operates on video blocks within individual video frames (or other independently coded units such as slices) in order to encode the video blocks. Frames, slices, portions of frames, groups of pictures, or other data structures may be defined as independent data units that include a plurality of video blocks, and syntax elements may be included at such different independent data units. The video blocks within independent data units may have fixed or varying sizes, and may differ in size according to a specified coding standard. In some cases, each video frame may include a series of independently decodable slices, and each slice may include one or more macroblocks or LCUs.

Macroblocks are one type of video block defined by the ITU H.264 standard and other standards. Macroblocks typically refer to 16 by 16 blocks of data. The ITU-T H.264 standard supports intra prediction in various block sizes, such as 16 by 16, 8 by 8, or 4 by 4 for luma components, and 8 by 8 for chroma components, as well as inter prediction in various block sizes, such as 16 by 16, 16 by 8, 8 by 16, 8 by 8, 8 by 4, 4 by 8 and 4 by 4 for luma components and corresponding scaled sizes for chroma components. For example, whereas ITU-T H.264 provides nine intra-prediction modes, HM provides at least thirty-four intra-prediction modes.

The emerging HEVC standard defines new terms for video blocks. In particular, with HEVC, video blocks (or partitions thereof) may be referred to as “coding units.” With the HEVC standard, largest coding units (LCUs) may be divided into smaller and smaller coding units (CUs) according to a quadtree partitioning scheme, and the different CUs that are defined in the scheme may be further partitioned into so-called prediction units (PUs) and/or transform units (TUs). The LCUs, CUs, and PUs, and TUs are all video blocks within the meaning of this disclosure. Other types of video blocks may also be used, consistent with the HEVC standard or other video coding standards. Thus, the phrase “block” refers to any size of video block. Moreover, video blocks may sometimes refer to blocks of video data in the pixel domain, or blocks of data in a transform domain such as a discrete cosine transform (DCT) domain, a domain similar to DCT, a wavelet domain, or the like. In addition, a block of data as described herein may refer to a luma block, sub-sampled chroma block, or both a luma block and two sub-sampled chroma blocks.

Referring again to FIG. 1, video encoder 122 may perform predictive coding in which a video block being coded is compared to another block of video data in order to identify a predictive block. This process of predictive coding is often referred to as motion estimation and motion compensation. Motion estimation estimates video block motion relative to one or more predictive video blocks of one or more predictive frames (or other coding units). Motion compensation generates the desired predictive video block from the one or more predictive frames or other coding units. Motion compensation may include an interpolation process in which interpolation filtering is performed to generate predictive data at fractional pixel precision.

After generating the predictive block, the differences between the current video block being coded and the predictive block are coded as a residual block, and prediction syntax (such as a motion vector) is used to identify the predictive block. The residual block may be transformed and quantized. Transform techniques may comprise a DCT process or conceptually similar process, integer transforms, wavelet transforms, or other types of transforms. In a DCT or DCT-like process, as an example, the transform process converts a set of pixel values (e.g., residual values) into transform coefficients, which may represent the energy of the pixel values in the frequency domain. Quantization is typically applied on the transform coefficients, and generally involves a process that limits the number of bits associated with any given transform coefficient.

Following transform and quantization, entropy coding may be performed on the transformed and quantized residual video blocks. Syntax elements, various filter syntax information, and prediction vectors defined during the encoding may be included in the entropy-coded bitstream. In general, entropy coding comprises one or more processes that collectively compress a sequence of quantized transform coefficients and/or other syntax information. Scanning techniques, such fixed or adaptive scan orders, are performed on the quantized transform coefficients in order to define one or more serialized one-dimensional vectors of coefficients from two-dimensional video blocks. For example, according to the techniques described herein, both fixed and adaptive scan techniques may be used, for different coefficients of a video block. Once scanned to generate the one or more serialized one-dimensional vectors, the scanned coefficients are then entropy coded along with any syntax information.

As part of the encoding process, encoded video blocks may be decoded to generate the video data used for subsequent prediction-based coding of subsequent video blocks. At this stage, filtering may be employed in order to improve video quality, and e.g., remove blockiness or other artifacts from decoded video. This filtering may be in-loop or post-loop. With in-loop filtering, the filtering of reconstructed video data occurs in the coding loop, which means that the filtered data is stored by an encoder or a decoder for subsequent use in the prediction of subsequent image data. In contrast, with post-loop filtering, the filtering of reconstructed video data occurs out of the coding loop, which means that unfiltered versions of the data are stored by an encoder or a decoder for subsequent use in the prediction of subsequent image data.

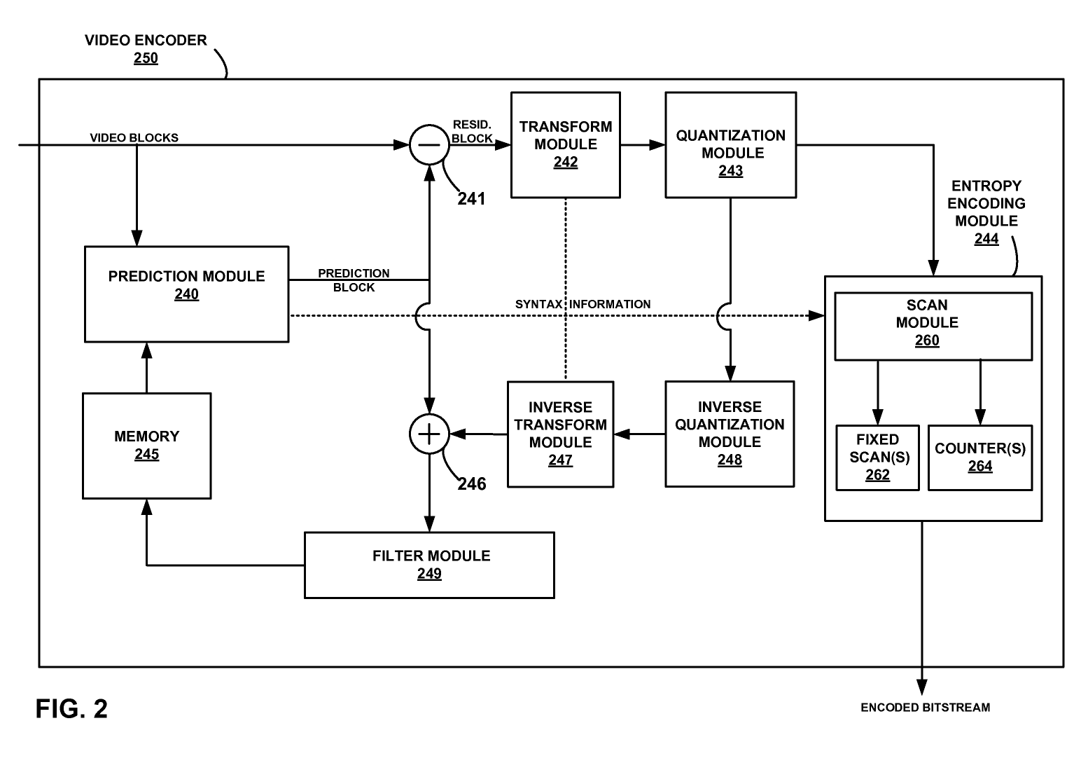

FIG. 2 is a block diagram illustrating an example video encoder 250 consistent with this disclosure. Video encoder 250 may correspond to video encoder 122 of source device 100, or a video encoder of a different device. As shown in FIG. 2, video encoder 250 includes a prediction module 240, adders 241 and 246, and a memory 245. Video encoder 250 also includes a transform module 242 and a quantization module 243, as well as an inverse quantization module 248 and an inverse transform module 247. Video encoder 250 also includes an entropy coding module 244. Entropy coding module 244 includes a scan module 260.

During the encoding process, video encoder 250 receives a video block to be coded, and prediction module 240 performs predictive coding techniques. For inter coding, prediction module 240 compares the video block to be encoded to various blocks in one or more video reference frames or slices in order to define a predictive block. For intra coding, prediction module 240 generates a predictive block based on neighboring data within the same frame, slice, or other unit of video data. Prediction module 240 outputs the prediction block and adder 241 subtracts the prediction block from the video block being coded in order to generate a residual block.

For inter coding, prediction module 240 may comprise motion estimation and motion compensation modules (not depicted in FIG. 2) that identify a motion vector that points to a prediction block and generates the prediction block based on the motion vector. Typically, motion estimation is considered the process of generating the motion vector, which estimates motion. For example, the motion vector may indicate the displacement of a predictive block within a predictive frame relative to the current block being coded within the current frame. Motion compensation is typically considered the process of fetching or generating the predictive block based on the motion vector determined by motion estimation. For intra coding, prediction module 240 generates a predictive block based on neighboring data within the same frame, slice, or other unit of video data. One or more intra-prediction modes may define how an intra prediction block can be defined.

Motion compensation for inter-coding may include interpolations to sub-pixel resolution. Interpolated predictive data generated by prediction module 240, for example, may be interpolated to half-pixel resolution, quarter-pixel resolution, or even finer resolution. This permits motion estimation to estimate motion of video blocks to such sub-pixel resolution.

After prediction module 240 outputs the prediction block, and after adder 241 subtracts the prediction block from the video block being coded in order to generate a residual block, transform module 242 applies a transform to the residual block. The transform may comprise a discrete cosine transform (DCT), an integer transform, or a conceptually similar transform such as that defined by the ITU H.264 standard, the HVEC standard, or the like. In some examples, transform module 242 may perform differently sized transforms and may select different sizes of transforms for coding efficiency and improved compression. Wavelet transforms, integer transforms, sub-band transforms or other types of transforms may also be used. In any case, transform module 242 applies a particular transform to the residual block of residual pixel values, producing a block of residual transform coefficients. The transform may convert the residual pixel value information from a pixel domain to a frequency domain.

Inverse quantization module 248 and inverse transform module 247 apply inverse quantization and inverse transform, respectively, to reconstruct the residual block in the pixel domain. Summer 246 adds the reconstructed residual block to the prediction block produced by prediction module 240 to produce a reconstructed video block for storage in memory 245. Filter module 249 may perform in-loop or post loop filtering on reconstructed video blocks.

Memory 245 may store a frame or slice of blocks for use in motion estimation with respect to blocks of other frames to be encoded. Prior to such storage, in the case of in-loop filtering, filter module 249 may apply filtering to the video block to improve video quality. Such filtering by filter module 249 may reduce blockiness or other artifacts. Moreover, filtering may improve compression by generating predictive video blocks that comprise close matches to video blocks being coded. Filtering may also be performed post-loop such that the filtered data is output as decoded data, but unfiltered data is used by prediction module 240.

Quantization module 243 quantizes the residual transform coefficients (e.g., from transform module 242) to further reduce bit rate. Quantization module 243, for example, may limit the number of bits used to code each of the coefficients. After quantization, entropy encoding module 244 may scan and entropy encode the data. For example, entropy encoding module 244 may scan the quantized coefficient block from a two-dimensional representation to generate one or more serialized one-dimensional vectors. For example, scan module 260 may perform a scan of a two-dimensional matrix that represents a quantized coefficient block. According to the techniques described herein, scan module 260 may perform an adaptive scan for a first plurality of coefficients of the quantized coefficient block, and perform a fixed scan for a second plurality of coefficients of the block, to generate the one or more serialized one-dimensional vectors.

For example, as shown in FIG. 2, entropy encoding module 244 may include one or more predetermined scan patterns 262, and/or one or more counters 264. Predetermined scan patterns 262 may define one or more predetermined scan orders of transform coefficients. For example, predetermined scan patterns 262 may define one or more of a horizontal scan, a vertical scan, a zig-zag scan, and/or inverse horizontal vertical scan, and zig-zag scans, any combination of such predetermined scan patterns, as well as other predetermined scan patterns. In some examples, predetermined scan patterns 262 may be defined based on data stored in a memory 245 associated with encoder 250. In other examples, predetermined scan patterns 262 may be defined by encoder 250 based on one or more equations, rules, or formulas.

According to one example, encoder 250 may identify one or more of predetermined scan patterns 262 based on a training sequence. For example, during such a training sequence, encoder 250 may encode a plurality of video blocks and determine a frequency at which coefficient positions within the blocks include non-zero coefficients. Based on such a training sequence, video encoder 250 may identify one or more predetermined scan patterns 262, and use such a predetermined scan pattern either as an initial scan pattern to adaptively scan a first plurality of coefficient positions within a block, or as a fixed scan pattern of a second plurality of coefficient positions within the block according to the techniques described herein.

According to the techniques described herein, for a first plurality of transform coefficient positions, scan module 260 may begin scanning a plurality of blocks of video data using an initial scan pattern defined by one or more of predetermined scan patterns 262. As the blocks are encoded, scan module 260 may use counters 264 to count a number of times each of the first plurality of coefficient positions within the blocks has a non-zero value. As the blocks are encoded, scan module 260 may adapt an order in which the first plurality of coefficient positions of the blocks are scanned, relative to the order used for at least one previously scanned block of the plurality of blocks. For example, scan module 260 may adapt the scan of the first plurality of coefficients such that a position that counters 264 indicate has a non-zero coefficient more often than other locations is scanned earlier, even though some of the other locations may be scanned earlier according to the initial predetermined scan pattern. In this manner, the scan order is adapted or adjusted on the fly based on the counter values associated with locations for the first plurality of coefficients.

According to the techniques described herein, scan module 260 may optionally not adaptively scan the second plurality of transform coefficient positions within the blocks. For example, scan module 260 may optionally not include one or more counters 264 configured to count a number of times each of the second plurality of coefficient positions within the blocks has a non-zero coefficient. Instead, for the second plurality of coefficient positions, scan module 260 may use one or more of predetermined scan patterns 262, for each encoded block of video data. The one or more predetermined scans patterns 262 used to scan the second plurality of coefficient positions may be the same, or different, than the one or more initial scan patterns that scan module 260 may use to begin adaptively scanning the first plurality of transform coefficient positions.

In some examples, for each encoded block of video data, scan module 260 may select one or more initial scan patterns from the plurality of predetermined scan patterns 262 that may be stored in memory 245 and/or automatically determined without being stored in memory 245. In some examples, the plurality of predetermined scan patterns 262 may comprise horizontal, vertical, zig-zag, inverse horizontal, vertical, and/or zig-zag, or any other predetermined scan pattern. Scan module 260 may select the initial scan pattern based on one or more characteristics of a scanned block of video data. For example, scan module 260 may select the initial scan based on one or more of a prediction type (e.g., inter, intra) of a block, whether the block is luma or chroma, a size of the block, and/or other characteristics of the block.

In some examples, for the first plurality of transform coefficients, counters 264 may be configured to collect statistics specific to each of a plurality of different predetermined scans patterns 262 that may be selected by scan module 260 as an initial scan pattern used to begin adaptively scanning the first plurality of transform coefficients. For example, counters 264 may include a plurality of counters each configured to count whether positions for the first plurality of transform coefficients in each of the respective different initial scan patterns 262 have a non-zero coefficient. For example, where scan module 260 is configured to select from among a horizontal scan, a vertical scan, and a zig-zag scan, counters 264 may include horizontal scan counters, vertical scan counters and zig-zag scan counters. The counters 264 may each be configured to count, as blocks of video data are being encoded, how often transform coefficients at respective positions within the block (i.e. positions within the respective two-dimensional matrix) have a non-zero value. Depending on an initial scan selected by scan module 260 to encode a first plurality of coefficients of a block, scan module 260 may apply statistics from a counter associated with the selected initial scan to adaptively scan the first plurality of transform coefficients. For example, if an adapted horizontal scan order is to be used to adaptively scan a block of transform coefficients, scan module 260 may access a counter dedicated to the initial horizontal scan pattern to adjust a scan order of transform coefficients of a block associated with the initial horizontal scan, and use the adjusted horizontal scan order to adaptively scan the first plurality of transform coefficients of the block. However, if an adapted vertical scan order is to be used to adaptively scan the first plurality of transform coefficients, scan module 260 may access a different counter dedicated to the vertical scan pattern to adjust the scan order associated with the initial vertical scan.

As described above, scan module 260 may use one or more of counters 264 to adjust a scan order associated with an initial predetermined scan and use the adjusted scan order to scan a first plurality of transform coefficients of a block of video data, and use predetermined scan patterns 262 (e.g., without using counters 264) to scan a second plurality of transform coefficients of the block, without using counters 264. Counters 264 and predetermined scan patterns 262 are illustrated as part of entropy encoding module 244, insofar as scan module 260 applies the respective tables. Counters 264 and/or predetermined scan patterns 262, however, may actually be stored in a memory location, such as memory 245. In some examples, counters 264 may comprise a location in memory where an indication of a number of non-zero coefficients is stored for access by scan module 260. As another example, predetermined scan patterns 262 may comprise one or more tables, mathematical relationships, or other indication of a predetermined scan order. In other examples, one or more of predetermined scan patterns 262 may also be automatically determined by decoder 250 using one or more equations, rules, and/or formulas. According to some such examples, one or more predetermined scan patterns 262 may optionally not be stored in memory 245.

Following this scanning process, entropy encoding module 244 encodes the quantized transform coefficients (along with any syntax elements) according to an entropy coding methodology as described herein to further compress the data. Syntax information included in the entropy encoded bitstream may include prediction syntax from prediction module 240, such as motion vectors for inter coding or prediction modes for intra coding. Syntax information included in the entropy encoded bitstream may also include filter information, such as that applied for interpolations by prediction module 240 or filters applied by filter module 249. In addition, syntax information included in the entropy coded bitstream may also include one or more VLC code words that represent one or more of syntax elements (or other information).

Following the entropy coding by entropy encoding module 244, the encoded video may be transmitted to another device or archived for later transmission or retrieval. For example, a decoder may use a one-dimensional vector of transform coefficients of the encoded video, generated by entropy encoding module 244, to reconstruct a two-dimensional matrix that represents a block of video data.

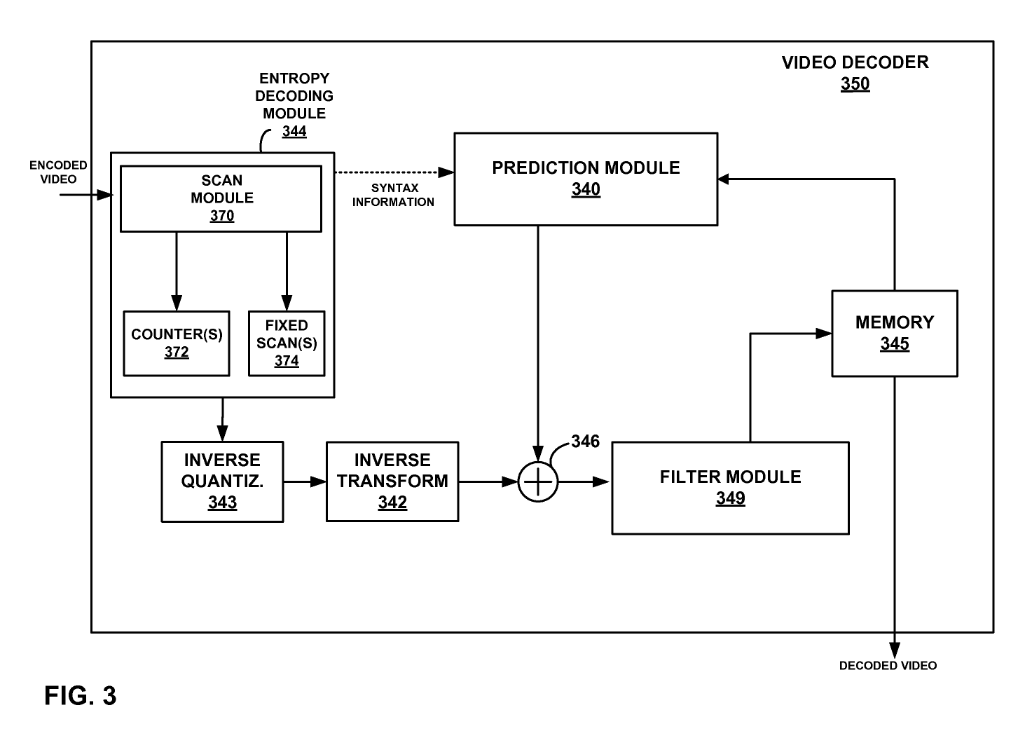

FIG. 3 is a block diagram illustrating an example of a video decoder 350, which decodes a video sequence that is encoded in the manner described herein. The received video sequence may comprise an encoded set of image frames, a set of frame slices, a commonly coded group of pictures (GOPs), or a wide variety of coded video units that include encoded video blocks and syntax information to define how to decode such video blocks.

Video decoder 350 includes an entropy decoding module 344, which performs the reciprocal decoding function of the encoding performed by entropy encoding module 244 of FIG. 2. In particular, entropy decoding module 344 may convert entropy encoded video blocks in a one-dimensional serialized format back into a two-dimensional block format. The number and size of the vectors, as well as the scan order defined for the video blocks, may define how the two-dimensional block is reconstructed.

For example, according the techniques of this disclosure, entropy decoding module 344 includes scan module 370. Scan module 370 may be configured to use an adaptive scan technique to scan a first plurality of coefficients to convert an entropy encoded video block from a one-dimensional serialized vector of coefficients, back into a two-dimensional matrix that the serialized vector was generated from. Scan module 370 may use a fixed scan technique to scan a second plurality of coefficients, to convert the encoded video block from the one-dimensional serialized vector back to the two-dimensional matrix. For example, for the first plurality of coefficients, scan module 370 may modify an order in which coefficients of the one-dimensional serialized vector are assigned to positions within the two-dimensional matrix, relative to an order in which coefficients of at least one previous block of video data were assigned to the positions of the two-dimensional matrix. For the second plurality of coefficients, scan module 370 may optionally not modify a scan order of the second plurality of transform coefficients of the block. Instead, for the second plurality of coefficients, scan module 370 may apply a fixed scan order that does not change, for each decoded block of video data (e.g., each received one-dimensional serialized vector).

For example, as shown in FIG. 3, entropy decoding module 344 may include one or more predetermined scan patterns 372, and/or one or more counters 374. Predetermined scan patterns 372 may define a predetermined scan order of transform coefficients. For example, predetermined scan patterns 372 may define one or more of a horizontal scan, a vertical scan, a zig-zag scan, and/or inverse horizontal vertical scan, and zig-zag scans, inverse horizontal, vertical, and/or zig-zag scans, any combination of such scans, and/or any other predetermined scan pattern.

For the first plurality of coefficients, scan module 370 may begin scanning a plurality of blocks of video data using an initial scan order of one or more of predetermined scan patterns 262. For example, based on the scan order, scan module 370 may begin assigning the first plurality of transform coefficients of the plurality of one-dimensional vectors to positions within the two-dimensional matrix that correspond to the plurality of blocks. As the blocks are decoded, scan module 370 may use counters 374 to count a number of times each of the first plurality of coefficient positions within the blocks has a non-zero value. As the blocks are decoded, based on the counter values, scan module 370 may adapt an scan order according to which of the first plurality of transform coefficients of the blocks are assigned to coefficient positions within the two-dimensional matrix, relative to at least one previously scanned block (e.g., relative to the initial predetermined scan pattern).

According to the techniques described herein, scan module 370 may optionally not adaptively assign the second plurality of transform coefficients of the blocks. For example, scan module 370 may optionally not include one or more counters 374 configured to count a number of times each coefficient within the blocks has a non-zero value. Instead, for the second plurality of coefficients, scan module 370 may use one or more of predetermined scan patterns 262, for each decoded block of video data. The one or more predetermined scan patterns 262 used to scan the second plurality of coefficients may be the same, or a different, scan pattern than an initial scan pattern that scan module 370 used to adaptively scan the first plurality of transform coefficients.

In some examples, for a first plurality of coefficients of each decoded block of video data, scan module 370 may select an initial scan pattern from a plurality of predetermined scan patterns 372. In some examples, predetermined scan patterns 372 may be defined based on data stored in a memory 345 associated with decoder 350. In other examples, predetermined scan patterns 372 may be defined by decoder 250 based on one or more equations, rules and/or formulas. Such a predetermined scan pattern may optionally be stored in memory 345.

In some examples, decoder 350 may determine one or more of predetermined scan patterns 372 based on a training sequence. For example, during such a training sequence, decoder 350 may decode a plurality of video blocks and determine a frequency at which coefficient positions within the blocks include non-zero coefficients. Based on such a training sequence, video decoder 350 may define one or more predetermined scan patterns 372, and use such a predetermined scan pattern either as an initial scan pattern to adaptively assign a first plurality of coefficients of the one-dimensional vector to positions within the two-dimensional matrix, or as a fixed scan pattern of a second plurality of coefficients of the one-dimensional vector to positions within the two-dimensional matrix according to the techniques described herein.

According to the techniques described herein, for a first plurality of transform coefficient positions, scan module 370 may select the initial scan pattern based on one or more characteristics of a scanned block of video data. For example, scan module 370 may select the initial scan pattern based on one or more of a prediction type (e.g., inter, intra) of a block, whether the block is luma or chroma, a size of the block, and/or other characteristics of the block.

In some examples, for the first plurality of transform coefficients, counters 374 may be configured to collect statistics specific to each of a plurality of predetermined scan patterns 372 that may be selected by scan module 370 as an initial scan pattern used to adaptively scan the first plurality of transform coefficients. For example, counters 374 may include a plurality of counters each configured to count whether each of the first plurality of transform coefficient positions in each respective predetermined scan pattern has a non-zero coefficient. For example, where scan module 370 is configured to select from among a horizontal scan, a vertical scan, a zig-zag scan, counters 374 may include horizontal scan counters, vertical scan counters, and zig-zag scan counters. The counters 374 may each be configured to count, as blocks of video data are being encoded, how often the first plurality of transform coefficients at respective positions within the block (i.e. positions of the selected initial scan pattern) have a non-zero value.

For example, if an adapted horizontal scan is to be used to adaptively assign a block of transform coefficients to positions within a two-dimensional matrix, scan module 370 may access a counter dedicated to the initial horizontal scan pattern to adjust a scan order of transform coefficients of the block associated with the initial horizontal scan, and use the adjusted horizontal scan order to adaptively assign the first plurality of transform coefficients of the block to positions within the two-dimensional matrix. However, if an adapted vertical scan is to be used to adaptively assign the first plurality of transform coefficients to positions within the two-dimensional matrix, scan module 370 may access a different counter dedicated to the vertical scan pattern to adjust the scan order associated with the initial vertical scan.

As described above, scan module 370 may use one or more of counters 374 to adjust a scan order associated with an initial predetermined scan and use the adjusted scan order to assign a first plurality of transform coefficients of a block of video data to positions within a two-dimensional matrix, and use predetermined scan patterns 372 (e.g., without using counters 374) to assign a second plurality of transform coefficients of the block to positions within the two dimensional matrix without using counters 374. Counters 374 and predetermined scan patterns 372 are illustrated as part of entropy encoding module 344, insofar as scan module 370 applies the respective tables. Counters 374 and/or predetermined scan patterns 372, however, may actually be stored in a memory location, such as memory 345. In some examples, counters 374 may comprise a location in memory where an indication of a number of non-zero coefficients is stored for access by scan module 370. In some examples, as described above, predetermined scan patterns 372 may optionally not be stored in memory 345. Instead, predetermined scan patterns 372 may be automatically determined by decoder 350, as described above.

As depicted in FIG. 3, video decoder includes a filter module 349. Filter module 349 may perform in-loop or post loop filtering on reconstructed video blocks. Video decoder 350 also includes a prediction module 340, an inverse quantization unit 343, an inverse transform module 342, a memory 345, and a summer 346.

A wide variety of video compression technologies and standards perform spatial and temporal prediction to reduce or remove the redundancy inherent in input video signals. As explained above, an input video block is predicted using spatial prediction (i.e., intra prediction) and/or temporal prediction (i.e., inter prediction or motion estimation). The prediction modules described herein may include a mode decision module (not shown) in order to choose a desirable prediction mode for a given input video block. Mode selection may consider a variety of factors such as whether the block is intra or inter coded, the prediction block size and the prediction mode if intra coding is used, and the motion partition size and motion vectors used if inter coding is used. A prediction block is subtracted from the input video block, and transform and quantization are then applied on the residual video block as described above.

The quantized coefficients, along with the mode information, may be entropy encoded to form a video bitstream. The quantized coefficients may also be inverse quantized and inverse transformed to form the reconstructed residual block, which can be added back to the prediction video block (intra predicted block or motion compensated block depending on the coding mode chosen) to form the reconstructed video block. An in-loop or post-loop filter may be applied to reduce the visual artifacts in the reconstructed video signal. The reconstructed video block is finally stored in the reference frame buffer (i.e., memory) for use of coding of future video blocks.

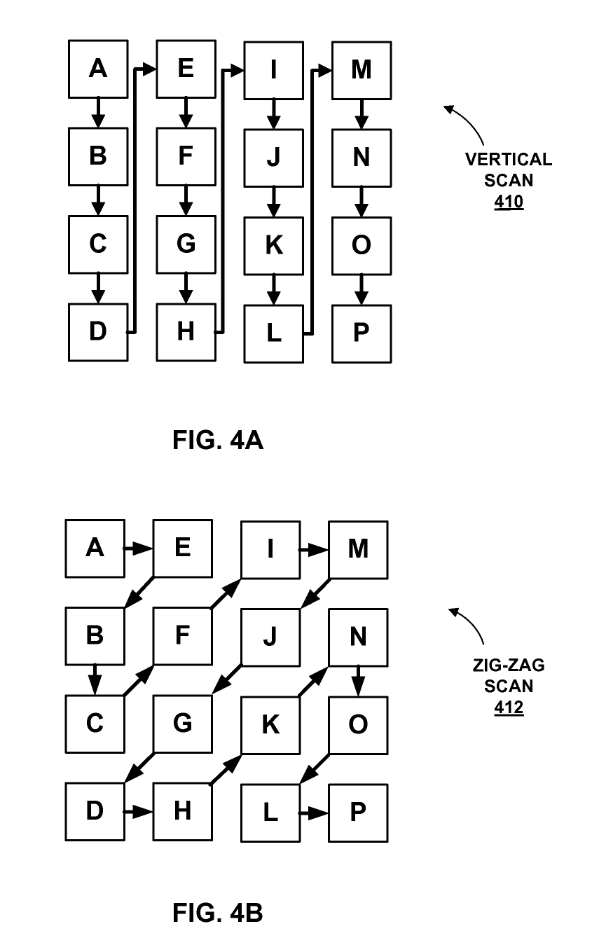

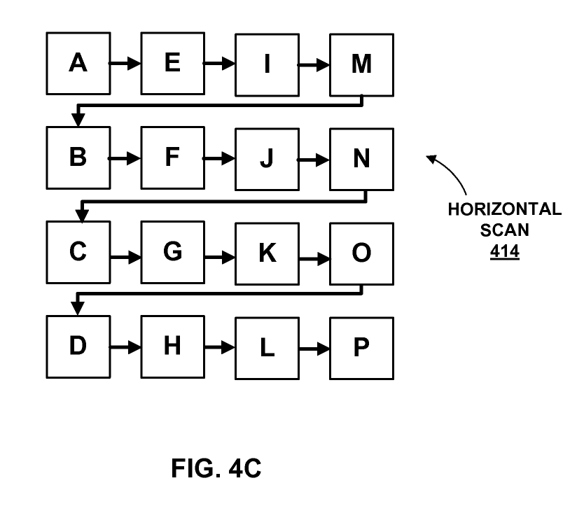

FIGS. 4A-4C are conceptual diagrams that illustrate various examples of predetermined scan patterns that may be used according to the techniques of this disclosure. For example, according to the techniques described herein, a coder (e.g., an encoder 250 depicted in FIG. 2, decoder 350 depicted in FIG. 3) may use one of more of the predetermined scan patterns depicted in FIGS. 4A-4C as an initial scan pattern to perform an adaptive scan for a first plurality of coefficients of a block. The coder may perform a fixed scan of a second plurality of coefficients of the block using one or more of the predetermined scan patterns depicted in FIGS. 4A-4C, for each block of video data that is coded. The first plurality of coefficients may be scanned before, or after, the second plurality of coefficients of the block. The examples of FIGS. 4A-4C are merely some examples of predetermined scan pattern that may be used as a fixed scan for a second plurality of transform coefficients. A predetermined scan order used as a fixed scan may have any scan order, as long as the scan order remains constant over time (across a plurality of blocks). According to other examples, a fixed scan as described herein may include scans that are partially horizontal (i.e. generally horizontally oriented) or partially vertical (i.e. generally vertically oriented), e.g., zig-zag scans with horizontal or vertical bias. Furthermore, a fixed scan as described herein could more generally define any constant and non-adaptive scan order.

Each of the examples of FIGS. 4A-4C depict a plurality of transform coefficients at positions A-P within a block of video data. FIGS. 4A-4C show examples of a predetermined scan patterns for a block of video data that includes sixteen transform coefficients, at positions A-P within a block of video data (i.e., a 4×4 block of video data). The 4×4 block of video data depicted in FIGS. 4A-4C is provided for purposes of explaining the techniques described herein. In other examples, a predetermined scan pattern as depicted in FIGS. 4A-4C may be performed on more, or fewer, coefficients of a block of video data, regardless of a size of the block of video data and/or a number of coefficients in the block. For example, according to the techniques described herein, a second plurality of coefficients of a block of video data may comprise 16 coefficients as illustrated in the examples of FIGS. 4A-4C, 64 coefficients (e.g., an 8×8 block), 256 coefficients (e.g., a 16×16 block), 1,024 coefficients (e.g., a 32×32 block), 4,096 coefficient (e.g., a 64×64 block) or even more coefficients.

FIGS. 4A-4C show 16 coefficients at positions A-P arranged in a two-dimensional matrix. To encode the coefficients A-P a video encoder 250 may read the coefficients A-P according to a scan order, and generate a serialized one-dimensional vector based on the order of the scan. For example, FIG. 4A shows a vertical coefficient scan 410. According to the vertical coefficient scan 410, video encoder 250 may read the coefficients A-P in columns from left to right. For example, as shown in FIG. 4A, encoder 250 may begin at coefficient A positioned at an upper-left corner of the two-dimensional matrix, and assign the coefficient A as a first coefficient of the serialized vector. According the vertical scan 410, encoder 250 may then assign coefficient B as a next coefficient in the serialized vector, assign coefficient C as a next coefficient in the serialized vector, and then assign coefficient D as a next coefficient in the serialized vector. Encoder 250 may then proceed to scan each of coefficients E-H, I-K, and M-P as coefficients of the serialized vector, until a last coefficient of the block (e.g., coefficient P) is reached. Once generated by the encoder 250 according to the vertical coefficient scan depicted in FIG. 4A, the serialized vector may have a coefficient order of A-B-C-D-E-F-G-H-I-J-K-L-M-N-O-P.

FIG. 4B depicts a zig-zag scan 412 of transform coefficients. According the example of FIG. 4B, to encode the coefficients A-P a video encoder 250 may read the coefficients A-P according to a zig-zag scan order, and generate a serialized one-dimensional vector based on the zig-zag scan order. According to the zig-zag coefficient scan of FIG. 4B, video encoder 250 may begin at coefficient A positioned at an upper-left corner of the two-dimensional matrix, and scan each coefficient in a zig-zag pattern until a last coefficient of the block is reached. For example, video encoder 250 may assign the coefficient A as a first coefficient of the serialized vector. According the zig-zag scan 412, encoder 250 may then assign coefficient E as a next coefficient in the serialized vector, assign coefficient B as a next coefficient in the serialized vector, and then assign coefficient C as a next coefficient in the serialized vector. Encoder 250 may then scan assign each of coefficients F, I, M, J, G, D, H, K, N, O, L, P to position in the serialized vector. Once generated according to the zig-zag coefficient scan 412 depicted in FIG. 4B, the serialized vector may have a coefficient order of A-E-C-B-F-I-M-J-G-D-H-K-N-O-L-P.

FIG. 4C depicts a horizontal scan 414 of transform coefficients. According the example of FIG. 4C, to encode the coefficients A-P a video encoder 250 may read the coefficients A-P according to a horizontal scan order, and generate a serialized one-dimensional vector based on the horizontal scan order. According to the horizontal scan 414 of FIG. 4C, video encoder 250 may begin at coefficient A positioned at an upper-left corner of the two-dimensional matrix, and scan each coefficient in rows from top to bottom until a last coefficient of the block is reached. According to the horizontal scan 414 of FIG. 4C, video encoder 250 may begin at coefficient A positioned at an upper-left corner of the two-dimensional matrix, and assign the coefficient A as a first coefficient of the serialized vector. According the horizontal scan 414, encoder 250 may then assign coefficient E as a next coefficient in the serialized vector, assign coefficient I as a next coefficient in the serialized vector, and then assign coefficient M as a next coefficient in the serialized vector. Encoder 250 may then scan each of coefficients B, F, J, N, C, G, K, O, D, H, L, P, I, M, J, G, D, H, K, N, O, L, P to assign them positions in the serialized vector, until a last coefficient of the block (e.g., coefficient P) is reached. Once generated according to the horizontal scan 414 depicted in FIG. 4C, the serialized vector may have a coefficient order of A-E-I-M-B-F-J-N-C-G-K-O-D-H-L-P.

FIGS. 4A-4C depict predetermined scan patterns that are non-inverse scan patterns, i.e., each of the scan patterns 410, 412, 414 begin at coefficient position in an upper leftmost corner of the block, and proceed until the coefficients of the block are scanned. According to other examples not depicted in FIGS. 4A-4C, predetermined scan patterns as described herein may comprise inverse scan patterns that begin at a transform coefficient position (e.g., at a lower rightmost corner of the block), and end at a coefficient position in an upper leftmost corner of the block. Again, any type of predetermined scan pattern may be used as an initial scan pattern for an adaptive scan, or as a fixed scan, according to the techniques described herein.

According to the techniques of this disclosure, encoder 250 may use an adaptive scan technique based on an initial, selected scan pattern, such as scans 410, 412, and 414 depicted in FIGS. 4A-4C where the scan is adaptively updated as blocks of video data are encoded, to encode a first plurality of coefficients of the blocks. For a second plurality of coefficients of the blocks, encoder 250 may use a fixed scan technique where one or more of scans 410, 412, and 414 depicted in FIGS. 4A-4C are not adaptively updated. According to such a fixed scan, encoder 250 may optionally not modify an order in which transform coefficients of a two-dimensional matrix (e.g., coefficients A-P depicted in FIGS. 4A-4C) are scanned as blocks of video data are being encoded by the encoder 250.

According to other examples, encoder 250 may use other types of predetermined scan patterns than scans 410, 412, and 414 depicted in FIGS. 4A-4C as a fixed scan pattern to scan a second plurality of transform coefficients (and/or as an initial scan pattern used to adaptively scan of the first plurality of coefficients) as described above. For example, encoder 250 may use one or more combinations of the various coefficients scans 410, 412, and 414 depicted in FIGS. 4A-4C, to scan the second plurality of coefficients using a fixed scan. For example, encoder 250 may apply a horizontal scan 414 as depicted in FIG. 4C to some coefficients of a fixed scan of the second plurality of coefficient, and apply a zig-zag scan 412 as depicted in FIG. 4B to scan a other coefficients of the second plurality of coefficients. According to the techniques described herein, to encode the second plurality of transform coefficients video encoder 250 may use any type of predetermined scan pattern as a fixed scan where an order in which transform coefficients of a two-dimensional matrix does not change from block to block.

In contrast, as described above, video encoder 250 may use an adaptive scan to encode a first plurality of transform coefficients of the video block. According to examples of an adaptive scan, video encoder 250 may begin encoding blocks of video data using one or more predetermined scan patterns such as those illustrated in FIGS. 4A-4C, and adapt an order in which at least one transform coefficient of the first plurality of transform coefficients is scanned, as the video encoder 250 encodes blocks of video data. For example, video encoder 250 may adapt the order in which the at least one coefficient is scanned, based on statistics that indicate how often the at least one coefficient (a position of the at least one coefficient) has a non-zero coefficient value.

According to the techniques described herein, a video decoder 350 may use an adaptive scan technique to code a first plurality of transform coefficients of a video block, and use a fixed scan, such as one or more of scans 410, 412, and 414 depicted in FIGS. 4A-4C, or other fixed scans to decode the video block. Video decoder 350 may use adaptive and fixed scans to scan a one-dimensional vector of transform coefficients to reconstruct a two-dimensional matrix of transform coefficients. For example, to reconstruct the two-dimensional matrix, video decoder 350 may read the first plurality of transform coefficients from the one-dimensional vector and assign the first plurality of coefficients to positions within the two-dimensional matrix using an adaptive scan, and assign the second plurality of coefficients to positions within the two-dimensional matrix, based on one or more predetermined scan patterns that are not adaptively updated.

Referring back to the example depicted in FIG. 4A, a fixed vertical scan 410 was used by encoder 250 to generate a one-dimensional vector of transform coefficients A-B-C-D-E-F-G-H-I-J-K-L-M-N-O-P. According to this example, video decoder 350 may reconstruct the original two-dimensional matrix of transform coefficient A-P using the predetermined vertical scan pattern 410 depicted in FIG. 4A. For example, video decoder 350 may read the transform coefficients from the one-dimensional vector, and assign them positions within the two-dimensional matrix in an order defined by the fixed vertical scan 410. For example, video decoder 350 may read a first coefficient of the one-dimensional vector (coefficient A), and assign that coefficient a position in an upper-left corner in a first column of the two-dimensional matrix. Video decoder 350 may then read and assign a second coefficient of the one-dimensional vector (coefficient B) a next position below the first coefficient (coefficient A) in the first column. Video decoder 350 may then assign a third coefficient of the one-dimensional vector (coefficient C) to a next position below the second coefficient (coefficient B) in the first column, and a fourth coefficient of the one-dimensional vector (coefficient D) to a next position below the third coefficient in the first column, until transform coefficients are assigned to all the positions in the first column of the two-dimensional matrix. Decoder 350 may then proceed, from left to right, to assign the remaining coefficients E-P of the one-dimensional vector to columns of the two-dimensional matrix, until a last coefficient of the block (coefficient P) is has been assigned a position within the two-dimensional matrix.

Video decoder 350 may similarly use one or more of scans 412, 414, 416 depicted in FIGS. 4A-4C, or any other type of predetermined scan pattern as a fixed scan of the one-dimensional vector used to reconstruct a two-dimensional matrix from a one-dimensional vector of transform coefficients, in order to decode a block of video data. As described above, for a first plurality of transform coefficients of the block, video decoder 350 may use an adaptive scan to reconstruct the two-dimensional matrix. Unlike the fixed scan of the second plurality of transform coefficients described above, for the first plurality of coefficients of the block, video decoder 350 may optionally not apply a same scan order for different blocks of video data. Instead, video decoder 350 may adaptively modify an order in which at least one of the first plurality of coefficients of the one-dimensional vector of transform coefficients are assigned to positions within the two-dimensional matrix to reconstruct the two-dimensional matrix of transform coefficients, relative to at least one previously decoded block of video data (e.g., an initial predetermined scan order of the adaptive scan).

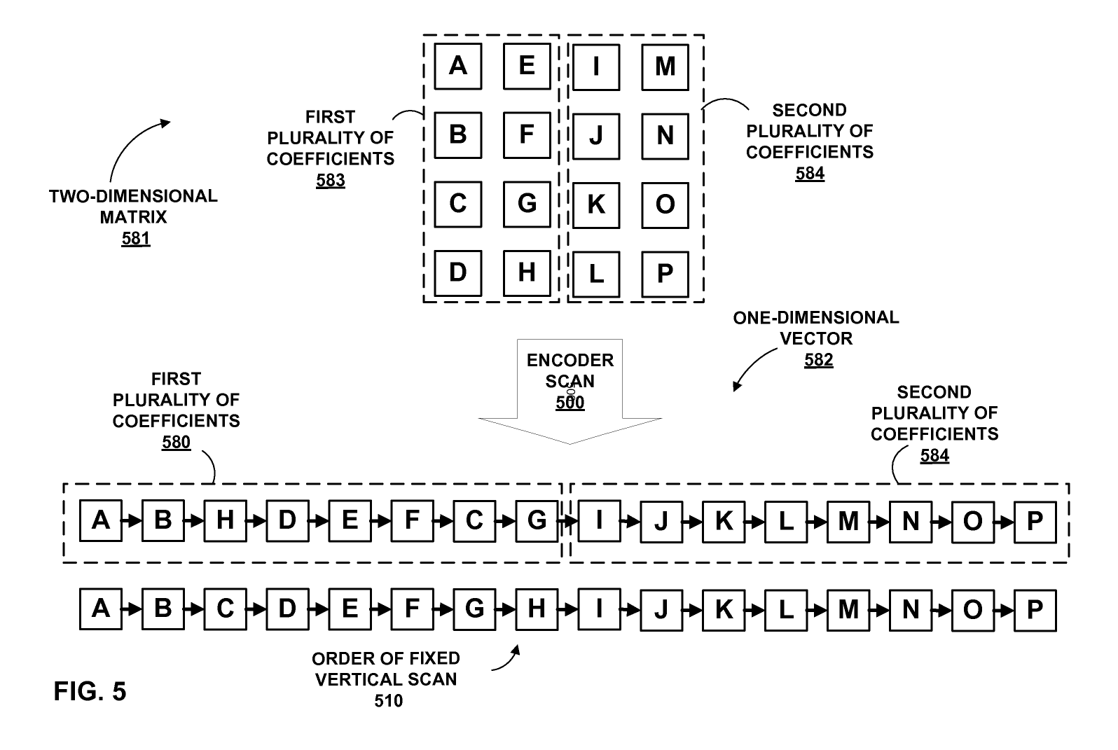

FIG. 5 is a conceptual diagram that illustrates one example of an encoder scan 500 of a two-dimensional matrix 581 of transform coefficient to generate a one-dimensional vector 582 of transform coefficients consistent with the techniques of this disclosure. As depicted in the example of FIG. 5, the two-dimensional matrix of transform coefficients A-P are arranged in rows and columns.

As shown in FIG. 5, the two-dimensional matrix 581 includes a first plurality of transform coefficients 583, and a second plurality of transform coefficients 584. According to the techniques described herein, video encoder 250 may use an adaptive scan technique to scan the first plurality of coefficients 583, and use a fixed scan technique to scan the second plurality of coefficients 584.

FIG. 5 illustrates one example in which first plurality of coefficients 583 is scanned using an adaptive scan, and second plurality of coefficients 584 are scanned using a vertical scan pattern 510, (e.g., vertical scan pattern 410 as depicted in FIG. 4A). As described herein, the terms “first” and “second,” are not used to indicate whether the first plurality of coefficients 583 is scanned before the second plurality of coefficients 584. Instead, the terms “first” and “second,” indicate that the first plurality of transform coefficients are different coefficients than the second plurality of transform coefficients. For example, according to the example of FIG. 5, a “first” plurality of coefficients 583 are scanned using an adaptive scan technique, and a “second” plurality of coefficients 584 are scanned using a fixed scan technique. In some examples, the encoder 250 may use an adaptive scan technique to scan the first plurality of transform coefficients 583 before the encoder uses a fixed scan to scan the second plurality of coefficients 584. In other examples, the encoder 250 may use the fixed scan technique to scan the second plurality of transform coefficients 584, before using an adaptive scan technique to scan the first plurality of transform coefficients 583.

The example of FIG. 5 is provided for exemplary purposes only. The techniques depicted in FIG. 5 may instead incorporate a zig-zag scan 412 depicted in FIG. 4B, a horizontal scan 414 depicted in FIG. 4C, an inverse horizontal or vertical scan, or any other type of fixed scan, where an order in which the second plurality of transform coefficients are scanned is not modified, as blocks of video data are encoded.

According to the example of FIG. 5, first plurality of coefficients 583 includes coefficients A-H, and second plurality of coefficients 584 includes coefficients I-P. According to the example of FIG. 5, second plurality of coefficients 584 are scanned using a fixed vertical scan pattern 510 (e.g., vertical scan pattern 410 depicted in FIG. 4A). For example, as shown in FIG. 5, to perform the fixed vertical scan, the encoder 250 may read transform coefficients I-P in columns, from left to right. For example, video encoder 250 may assign a coefficient I (in an upper-left corner of the second plurality of transform coefficients 584 in the two-dimensional matrix) to a first position of the second plurality of coefficients 584 of the one-dimensional array. Video encoder 250 may continue to assign the remaining coefficients J-L of the first column of the second plurality of transform coefficients 584 to positions within the one-dimensional vector 582. Video encoder 250 may then assign coefficients M-P of a second column of transform coefficients to positions within the one-dimensional vector 582, until a last coefficient (coefficient P) of the second plurality of coefficients 584 is scanned to generate the one-dimensional vector 582. In this manner, video encoder 250 may scan the second plurality of coefficients 584 of the two-dimensional matrix 581, to generate the one-dimensional vector 582 that includes the second plurality of transform coefficients 584.

According to the example of FIG. 5, an order of a predetermined vertical scan pattern 510 is depicted, as if it had been applied to sixteen coefficients A-P of the block. For example, if vertical scan pattern 510 had been applied to each of coefficients of the block (e.g., as depicted in the example of FIG. 4A), the one-dimensional vector would have sixteen coefficient positions 1-16, defined by the vertical scan 510 of the two-dimensional matrix. As shown in the example of FIG. 5, the second plurality of coefficients 584 have an order that corresponds to the order of the predetermined vertical scan pattern 510. For example, as shown in FIG. 5, coefficients I-P are arranged consistent with positions 9-16 of the vertical scan pattern 510.

As also shown in FIG. 5, for the first plurality of transform coefficients 583, a video encoder 250 may scan coefficients A-H in an order inconsistent with the order of the predetermined vertical scan 510 (e.g., positions 1-8 of the vertical scan pattern 510). Instead, for the first plurality of coefficients 583, video encoder 250 may adaptively scan the first plurality of coefficients A-H. For example, video encoder 250 may adaptively scan the first plurality of coefficient A-H 583 based on statistics regarding one or more previously encoded blocks of video data. For example, video encoder 250 may modify an order in which at least one coefficient position of the first plurality of coefficients 583 is scanned to generate the one-dimensional vector 582, based on how often a coefficient at that position has a non-zero value (i.e., a non-zero coefficient).

For example, video encoder 250 may initially use a predetermined scan pattern, such as vertical scan 510, or any other predetermined scan pattern, to begin encoding blocks of video data. As video encoder 250 encodes blocks of video data, video encoder 250 may determine how frequently each of the first plurality of coefficient scan positions 583 has a non-zero value (e.g., coefficients of the block, at respective positions within the two-dimensional matrix). For example, video encoder 250 may employ one or more counters 264 that count, for each coefficient scan position A-H of the first plurality of coefficients 583, a number of times the coefficient scan position has a non-zero coefficient.

In some examples, such counters 264 may be specific to a particular predetermined scan initially used to adaptively scan the first plurality of coefficients. For example, according to the example of FIG. 5, where an adapted vertical scan is to be used, video encoder 250 may use statistics specific to the vertical scan pattern (e.g., a count value from counters 264 depicted in FIG. 2) to adaptively scan the first plurality of coefficients. In some examples, counters 264 may include other counters, dedicated to other predetermined scan patterns that may be used as an initial scan pattern of the adaptive scan. According to the techniques described herein, video encoder 250 may optionally not maintain any such counters, for the second plurality of coefficients 384.

With adaptive scanning, the coefficient positions with the higher count values, over time, will migrate towards to beginning of the scan order because the statistics define a higher likelihood that such coefficient positions (relative to other coefficient positions) will include non-zero coefficients. Thus, as the video encoder 250 encodes the blocks, if a particular coefficient position of the first plurality of coefficients 583 in the two-dimensional matrix has had more non-zero coefficients than another coefficient position of the first plurality of coefficients 583, video encoder 250 may scan the more frequently non-zero coefficient position before the less frequently non-zero coefficient position. For example, as shown in FIG. 5, an order of the adaptively scanned first plurality of coefficients A-N 583 is A-B-H-D-E-F-C-G to generate one-dimensional vector 582. Note that, as depicted in FIG. 5, if the coefficients A-N had been scanned according to vertical scan order 510, they would have been scanned in an order of A-B-C-D-E-F-G-H, consistent with the predetermined scan order for second plurality of coefficients I-P 584 depicted in FIG. 5.

As shown in the example of FIG. 5, due to adaptation, the first plurality of coefficients A-N are scanned in a different order than defined by vertical scan pattern 510. For example, as video encoder 250 encodes the blocks, video encoder 250 may determine, for each of coefficient positions A-H, a scan order based on how often the coefficient position has a non-zero coefficient. According to the example of FIG. 5, video encoder 250 may determine that coefficients at position A have had a non-zero value more often than any other of the first plurality of coefficient positions B-H, that coefficients at position B have had a non-zero value more often than any of coefficient positions C-H, and that coefficient a position H have had a non-zero value more often than any of coefficient positions D-G. As shown in FIG. 5, although the coefficient at position H would have been scanned eighth if scanned in a predetermined vertical scan pattern 510, according to the adaptive scan of the first plurality of transform coefficients 583, video encoder 250 may scan a coefficient at position H before it scans any of coefficients C-G, because coefficient position H has had a non-zero value more often than any of coefficients C-G. In this manner, an order in which coefficient position H is scanned by encoder 250 to generate one-dimensional vector 582 has been modified, relative to a scan of at least one previously encoded block of video data. As also shown in FIG. 5, video encoder 250 may also adapt an order in which other coefficients E-G of the block of the two-dimensional matrix 581 are scanned relative to at least one previously encoded block. For example, as shown in FIG. 5, video encoder 250 may determine a scan order of A-B-H-D-E-F-C-G for the first plurality of coefficients 583, based on how often each coefficient position has had a non-zero coefficient.

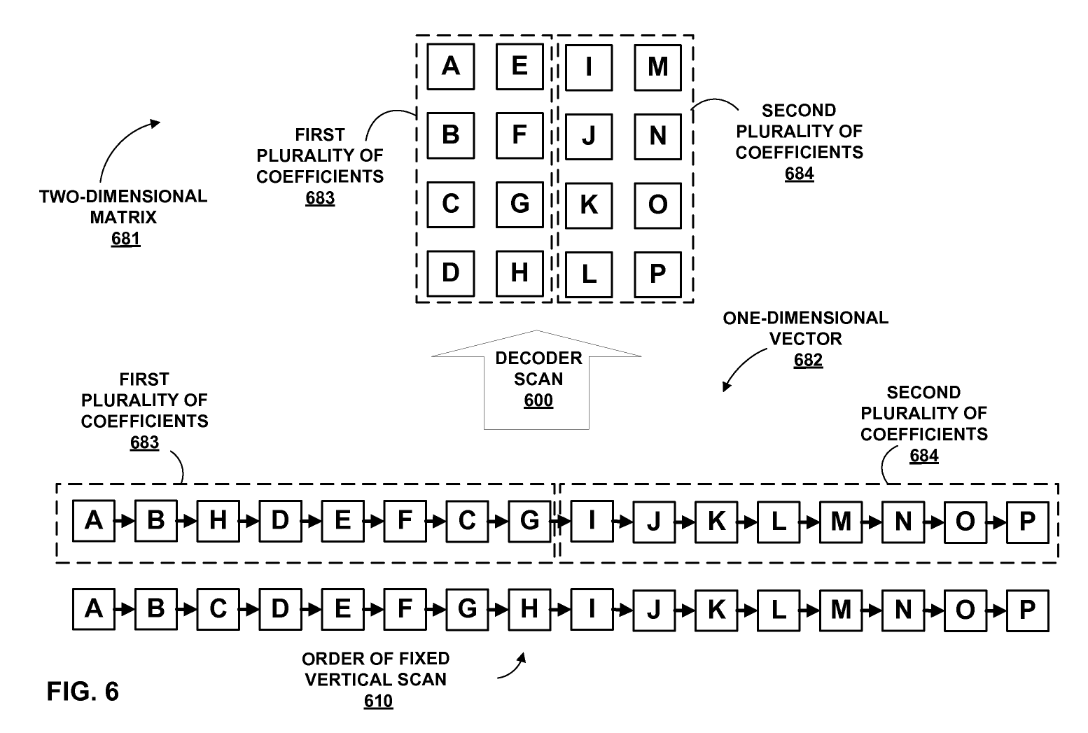

FIG. 6 is a conceptual diagram that illustrates one example of a decoder scan 600 of a one-dimensional vector 682 of transform coefficients to reconstruct a two-dimensional matrix 681 of transform coefficients consistent with the techniques of this disclosure.

As shown in FIG. 6, the one-dimensional vector 682 includes a first plurality of transform coefficients 683, and a second plurality of transform coefficients 684. According to the techniques described herein, video decoder 350 may use an adaptive scan technique to assign the first plurality of coefficients 683 of the one-dimensional vector 682 to assign coefficients of one-dimensional vector 682 to positions within the two-dimensional matrix 681, and use a fixed scan technique to assign second plurality of coefficients 684 of the one-dimensional vector 682 to positions within two-dimensional matrix 681, in order to reconstruct the two-dimensional matrix 681.

FIG. 6 illustrates one example in which first plurality of coefficients 683 is scanned using an adaptive scan, and second plurality of coefficients 684 are scanned using a fixed scan (e.g., a predetermined vertical scan pattern 410 as depicted in FIG. 4A).

The example of FIG. 6 is provided for exemplary purposes only. The techniques depicted in FIG. 6 may instead incorporate a zig-zag scan 412 depicted in FIG. 4B, a horizontal scan 414 depicted in FIG. 4C, or any other type of predetermined scan pattern, where an order in which the second plurality of transform coefficients are scanned is not modified, as blocks of video data are decoded.

According to the example of FIG. 6, first plurality of coefficients 683 includes coefficients A-H, and second plurality of coefficients 684 includes coefficients I-P. According to the example of FIG. 6, second plurality of coefficients 684 are scanned using a predetermined vertical scan pattern 610 (e.g., vertical scan pattern 410 depicted in FIG. 4A). For example, as shown in FIG. 6, to perform the fixed scan of the second plurality of coefficients 683, the video decoder 350 may read transform coefficients I-P from one-dimensional vector 682 and assign the coefficients to positions in two-dimensional matrix 681 in columns, from left to right. For example, video decoder 350 may assign a first coefficient I of the second plurality of transform coefficients 684 to a position in an upper-left corner of two-dimensional matrix 681. Video decoder 350 may continue to assign coefficients J-L of the to positions in the first column in the two-dimensional matrix 681. Video decoder may then assign coefficients M-P of the one-dimensional vector 682 to positions in a second column within the two-dimensional matrix 681, until a last coefficient (coefficient P) of the second plurality of coefficients 684 in the one-dimensional vector 682 is assigned a position within two-dimensional matrix 681. In this manner, video decoder 350 may assign the second plurality of coefficients of the one-dimensional vector to positions within the two-dimensional matrix 681, in order to reconstruct a two-dimensional matrix 681 that includes the second plurality of transform coefficients 684.

According to the example of FIG. 6, an order of a vertical scan pattern 610 is depicted, as if it had been applied to sixteen coefficients A-P of the one-dimensional vector 682. For example, if a vertical scan pattern 610 had been applied to each of coefficients of the one-dimensional vector 682 (e.g., as depicted in the example of FIG. 4A), the one-dimensional vector would be scanned consistent with the sixteen coefficient positions A-P, defined by the vertical scan 610 of the one-dimensional vector 682. As shown in the example of FIG. 6, the second plurality of coefficients 684 of the one-dimensional vector 682 are scanned in a fixed order that corresponds to the order of the vertical scan pattern 610. For example, as shown in FIG. 6, coefficients I-P are assigned according to a scan order consistent with positions 9-16 of the vertical scan 610.

As also shown in FIG. 6, for the first plurality of transform coefficients 683, due to adaptation, video decoder 350 may scan coefficients A-H in an order inconsistent with the order of vertical scan pattern 610 (e.g., positions A-H of the fixed vertical scan 610). Instead, video decoder 350 may adaptively scan the first plurality of coefficients A-H. Video decoder 350 may adaptively scan the first plurality of coefficient A-H 683, based on statistics regarding one or more previously encoded blocks of video data. For example, video decoder 350 may modify an order in which at least one coefficient of the first plurality of coefficients 683 of the one-dimensional vector 582 is assigned a position within the two-dimensional matrix 681, based on how often a coefficient position has had a non-zero coefficient.

For example, video decoder 350 may use vertical scan pattern 610, or any other predetermined scan pattern, as an initial scan pattern to begin decoding blocks of video data. As video decoder 350 decodes blocks of video data (e.g., one-dimensional vectors of transform coefficients), video decoder 350 may determine how frequently coefficients at each scan position of the first plurality of coefficients 683 has a non-zero value for one or more other blocks of video data. For example, video decoder 350 may employ one or more counters 374 that count, for each coefficient scan position A-H of the first plurality of coefficients 683, a number of times the coefficient scan position has had a non-zero coefficient. In some examples, such counters 374 may be specific to a particular predetermined scan pattern used as an initial scan pattern to adaptively scan the first plurality of coefficients. For example, according to the example of FIG. 6, where an adapted vertical scan is to be used to scan the first plurality of coefficients, video decoder 350 may use statistics specific to the vertical scan pattern (e.g., a count value from counters 374 depicted in FIG. 3) to adaptively scan the first plurality of coefficients. In some examples, counters 374 may include other counters, dedicated to other predetermined scan patterns. According to the techniques described herein, video decoder 350 may optionally not maintain any such counters, for the second plurality of coefficients 684.

As video decoder 350 decodes the blocks, if a particular coefficient position of the first plurality of coefficients 683 in the one-dimensional vector 682 has had more non-zero coefficients than another coefficient position of the first plurality of coefficients 683, video decoder 350 may scan the more frequently non-zero coefficient position before the less frequently non-zero coefficient position to assign the coefficient to a position within the two-dimensional matrix 681. For example, as shown in FIG. 6, video decoder 350 may read first plurality of coefficients A-N 683 from the one-dimensional vector to assign the coefficients positions within the two-dimensional matrix according to an order A-B-H-D-E-F-C-G to reconstruct two-dimensional matrix 681. Note that, if the coefficient positions A-H had been scanned according to vertical scan pattern 610, they would have been assigned to positions in an order of A-B-C-D-E-F-G-H, consistent with the initial scan pattern for second plurality of coefficients 684 as depicted in FIG. 6.

As shown in the example of FIG. 6, the first plurality of coefficients A-H are read from the one-dimensional vector 682 in a different order than predetermined vertical scan pattern 610. For example, as video decoder 350 decodes the blocks, video decoder 350 may determine, for each of coefficients A-H, a scan order based on how often the coefficient position has had a non-zero coefficient. According to the example of FIG. 6, video decoder 350 may determine that coefficient position H has had a non-zero value more often than positions C-G, that coefficient position D has had a non-zero value more often than any of coefficient positions C and E-G, and that coefficient position E has had a non-zero value more often than any of coefficient positions C, F, and G. As shown in FIG. 6, although coefficient position H would have been scanned from the one-dimensional vector 682 eighth if scanned according to predetermined scan pattern 610, according to the adaptive scan of the first plurality of transform coefficients 683 video decoder 350 may assign a coefficient to position G within the two-dimensional matrix 681, before it assigns any coefficients to other positions, because coefficient position H has had a non-zero value more often than any of coefficient positions C-G. In this manner, an order in which coefficient position H is scanned by decoder 350 to reconstruct the two-dimensional matrix 681 has been modified, relative to an order in which coefficient positions of at least one previously decoded block of video data were assigned to positions within the two-dimensional matrix. As also shown in FIG. 6, video decoder 350 may also adapt an order in which other coefficient positions C-G of the one-dimensional vector 682 are scanned, relative to at least one previously encoded block. For example, as shown in FIG. 6, video decoder 350 may determine a scan order of A-B-H-D-E-F-C-G for the first plurality of coefficients 683, based on how often each coefficient position has had a non-zero coefficient.

According to the examples of FIGS. 5 and 6, a video coder (e.g., video encoder 250 and/or video encoder 350) perform a scan of transform coefficients that include sixteen coefficients, A-N (e.g., a 4×4 block of video data) according to the techniques of this disclosure. The examples of FIGS. 5 and 6 are provided for exemplary purposes only. In other examples, the coder may perform a scan according to the techniques of this disclosure for larger, or smaller, sized blocks of video data than depicted in FIGS. 5 and 6. For example, the coder may scan an 8×8, 16×16, 32×32, 64×64, or other size block of data using both adaptive and fixed scans as described herein. According to these examples, video encoder 250 may adaptively scan a first plurality of coefficients with less, or more, coefficients than video encoder 250 encodes with a fixed scan. For example, for example, for a 16×16 block that includes 256 transform coefficient, video encoder 250 may adaptively scan 64 coefficients of the block, and use a fixed scan for 192 coefficients of the block. According to another example, for the 16×16 block, video encoder 250 may adaptively scan sixteen coefficients of the block, and use a fixed scan for 240 coefficients of the block.

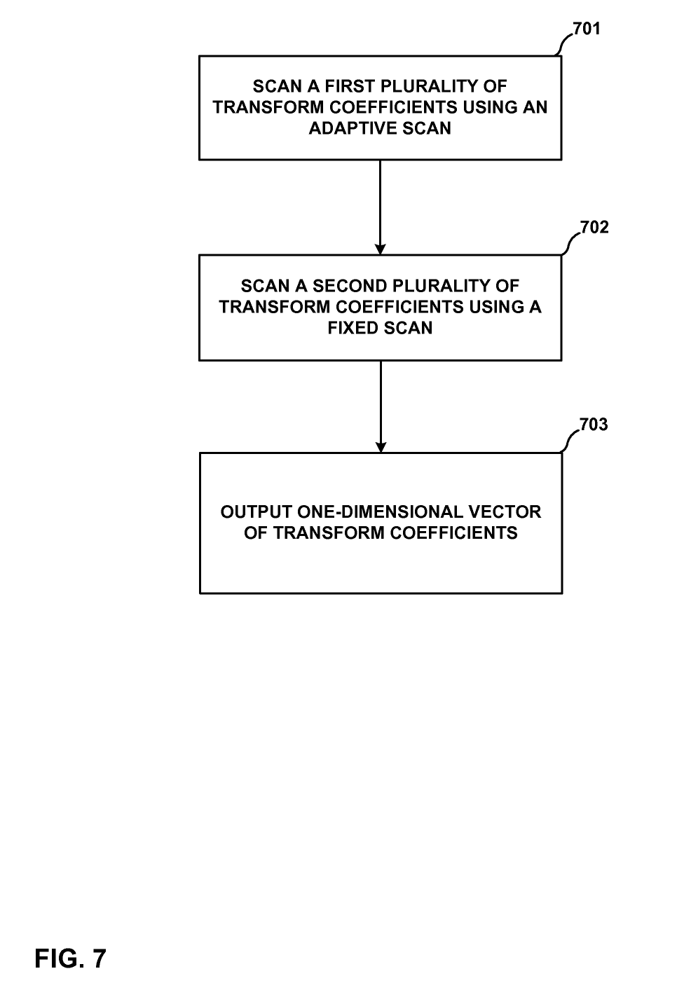

FIG. 7 is a flow chart diagram that depicts one example of a method of encoding a block of video data consistent with the techniques of this disclosure. The method of FIG. 7 is described as performed by video encoder 250, however any device may be used to perform the method of FIG. 7.

As shown in FIG. 7, video encoder 250 may adaptively scan a first plurality of transform coefficients of a two-dimensional matrix of transform coefficients, to generate a one-dimensional vector of transform coefficients (701). For example, as described above, to adaptively scan the first plurality of transform coefficients, video encoder 250 may modify an order in which the first plurality of transform coefficients are scanned, relative to at least one previously encoded block of video data (e.g., relative to an initial predetermined scan pattern used to adaptively scan the first plurality transform coefficients).

As also depicted in FIG. 7, video encoder 250 may use a fixed scan to scan a second plurality of coefficients of the two-dimensional matrix to generate the one-dimensional vector (702). For example, for the second plurality of coefficients, video encoder may optionally not modify an order in which the second plurality of coefficients are scanned, relative to at least one previously encoded block of video data. Instead, video encoder 250 may use a predetermined scan pattern to scan the second plurality of transform coefficients, for each block of transform coefficients video encoder 250 encoders.

As also depicted in FIG. 7, video encoder 250 may output the generated one-dimensional vector (703). For example, video encoder 250 may output the generated one-dimensional vector, as part of an entropy encoded bit stream. In some examples, a video decoder (e.g., video decoder 250 depicted in FIG. 5 may use the entropy encoded bit stream (e.g., including the generated one-dimensional vector of transform coefficients) to decode a block of video data, to reconstruct the two-dimensional matrix.

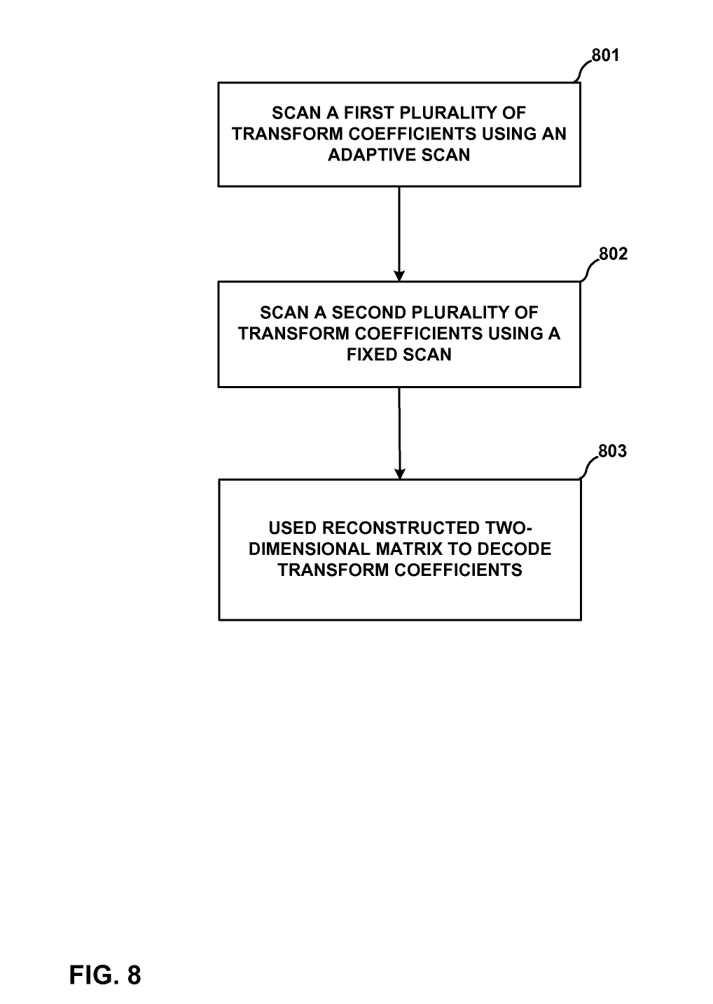

FIG. 8 is a flow chart diagram that depicts one example of a method of decoding a block of video data consistent with the techniques of this disclosure. The method of FIG. 8 is described as performed by video decoder 350, however any device may be used to perform the method of FIG. 8.

As shown in FIG. 8, video decoder 350 may use an adaptive scan for a first plurality of transform coefficients of a one-dimensional vector of transform coefficients, to reconstruct a two-dimensional matrix of transform coefficients (801). For example, as described above, for the first plurality of transform coefficients, video decoder 350 may adaptively modify a scan order in which at least one of the first plurality of transform coefficients are assigned to positions within the two-dimensional matrix, relative to at least one previously encoded block of video data.

As also depicted in FIG. 8, video decoder 350 may use a fixed scan for a second plurality of coefficients of the one-dimensional vector to reconstruct the two-dimensional matrix (802). For example, for the second plurality of coefficients, video decoder 350 may optionally not modify an order in which the second plurality of coefficients are assigned to positions within the two-dimensional matrix, relative to at least one previously encoded block of video data. Instead, as blocks of video data are decoded, video decoder 350 may use a predetermined scan pattern to assign the second plurality of coefficients of the one-dimensional vector to positions within the two-dimensional matrix.

As also depicted in FIG. 8, video decoder 350 may use the reconstructed two-dimensional matrix of transform coefficients, to decode a block of video data that includes the transform coefficients (803).

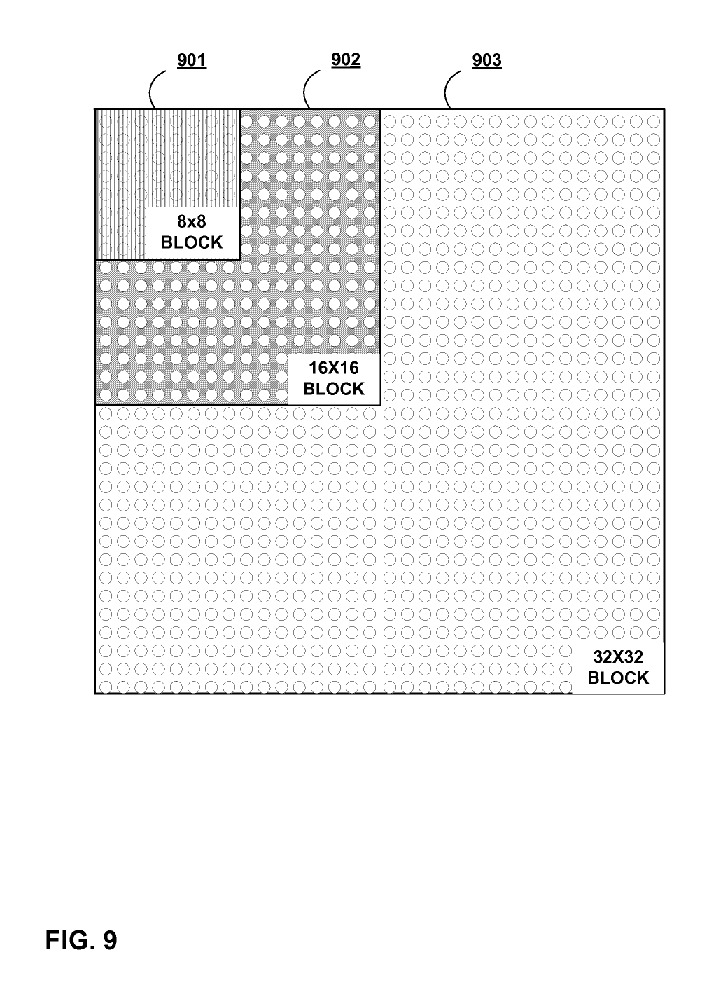

FIG. 9 is a conceptual diagram that illustrates one example of a block of video data that may be scanned according to the technique described herein. The example of FIG. 9 shows a 32×32 block of video data, that includes a first plurality of transform coefficients 901, a second plurality of transform coefficients 902, and a third plurality of transform coefficients 903. As depicted in FIG. 9, the 32×32 block of video data includes 1024 transform coefficients. As depicted in FIG. 9, the first plurality of transform coefficients 901 include an 8×8 block (64 transform coefficients) of transform coefficients arranged in an upper-left corner of the 32×32 block, the second plurality of transform coefficients 902 include a 16×16 block (256 coefficients also arranged in the upper-left corner of the 32×32 block) other than the first plurality of coefficients (240 coefficients), and the third plurality of coefficients 903 include the remaining coefficients (1024−256=768 coefficients) of the 32×32 block.

According to the techniques of this disclosure, a coder (e.g., video encoder 250 depicted in FIG. 2, video decoder 350 depicted in FIG. 3) may use an adaptive scan to code first number of coefficients 901, and use a fixed scan for second number of coefficients 902. For example, for first number of coefficients 901, the coder may adaptively update an order in which coefficients of the block (e.g., of a one-dimensional vector of coefficients, or a two-dimensional matrix of coefficients) are scanned. However, for the second plurality of coefficients 902, the coder may employ a fixed scan technique. Such a fixed scan may include using any combination of non-inverse, or inverse scan patterns as described herein. In some examples, the coder may scan the first plurality of coefficients 901, before coding the second plurality of coefficients 902. In other examples, the coder may scan the second plurality of coefficients 902, before coding the first plurality of coefficients 901.

In some examples consistent with the techniques of this disclosure, a coder may code a block of video data that includes a third plurality of coefficients 903, as depicted in the example of FIG. 9. In some examples, the coder may optionally not scan such a third plurality of coefficients. Instead, the coder may only scan (and/or code) the first plurality 901 and second plurality 902 of transform coefficients of the block of video data, using both adaptive and fixed scan techniques, as described herein. In this case, third plurality of coefficients 903 may optionally not be encoded by encoder 250. Instead, third plurality of coefficients 903 may be assumed to all have a value of zero.

The techniques described herein, including the example of FIG. 9 where at least some coefficients (e.g., a third plurality of coefficients) are not scanned by a coder, may provide improvements over other techniques for video coding. For example, by adaptively scanning a first plurality of transform coefficients of a block, and using a fixed scan technique for a second plurality of transform coefficients of the block, a coder may be configured to code blocks of video data of different sizes, with improved quality and/or efficiency of video coding.

In one or more examples, the functions described herein may be implemented at least partially in hardware, such as specific hardware components or a processor. More generally, the techniques may be implemented in hardware, processors, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium, i.e., a computer-readable transmission medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

Instructions may be executed by one or more processors, such as one or more central processing units (CPU), digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples been described. These and other examples are within the scope of the following claims.

1. A method for decoding a block of video data, comprising:
assigning a first plurality of transform coefficients of a one-dimensional vector of transform coefficients to positions within a two-dimensional matrix of transform coefficients using an adaptive scan to reconstruct the two-dimensional matrix of transform coefficients from the one-dimensional vector;
assigning a second plurality of transform coefficients of the one-dimensional vector to positions within the two-dimensional matrix of transform coefficients using a fixed scan to reconstruct the two-dimensional matrix from the one-dimensional vector; and
decoding the two-dimensional matrix of transform coefficients.

2. The method of claim 1, wherein assigning the first plurality of transform coefficients of the one-dimensional vector to positions within the two-dimensional matrix using the adaptive scan comprises modifying an order in which at least one of the first plurality of transform coefficients are assigned relative to a scan order of at least one previously coded block of video data.

3. The method of claim 2, further comprising:
determining how often a position of the at least one of the first plurality of transform coefficients comprises a non-zero coefficient for a plurality of previously decoded blocks of video data; and
modifying the order in which the at least one of the first plurality of coefficients are assigned based on determining how often the position of the at least one of the first plurality of transform coefficients comprises a non-zero coefficient for the plurality of previously decoded blocks of video data.

4. The method of claim 3, wherein modifying the order in which the at least one of the first plurality of coefficients is scanned comprises:
scanning a first coefficient position of the first plurality of coefficients that comprises a non-zero coefficient more often than a second coefficient position of the first plurality of coefficients, before scanning the second coefficient position.

5. The method of claim 1, wherein assigning the second plurality of transform coefficients of the one-dimensional vector to positions within the two-dimensional matrix of transform coefficients using the fixed scan comprises using one or more predetermined scan patterns selected from the group consisting of:
a vertical scan;
a horizontal scan;
a zig-zag scan;
an inverse vertical scan;
an inverse horizontal scan; and
an inverse zig-zag scan.

6. The method of claim 1, wherein the one-dimensional vector includes a third plurality of transform coefficients, and further comprising:
not scanning the third plurality of transform coefficients.

7. A video decoding device, comprising
a scan module configured to:
assign a first plurality of transform coefficients of a one-dimensional vector of transform coefficients to positions within a two-dimensional matrix of transform coefficients using an adaptive scan to reconstruct the two-dimensional matrix of transform coefficients from the one-dimensional vector;
assign a second plurality of transform coefficients of the one-dimensional vector to positions within the two-dimensional matrix of transform coefficients using a fixed scan to reconstruct the two-dimensional matrix from the one-dimensional vector; and
a video decoder configured to:
decode the reconstructed two-dimensional matrix of transform coefficients.

8. The device of claim 7, wherein the scan module is configured to assign the first plurality of transform coefficients of the one-dimensional vector to positions within the two-dimensional matrix using the adaptive scan based on modifying an order in which at least one of the first plurality of transform coefficients are assigned relative to a scan order of at least one previously coded block of video data.

9. The device of claim 8, wherein the scan module is further configured to:
determine how often a position of the at least one of the first plurality of transform coefficients comprises a non-zero coefficient for a plurality of previously decoded blocks of video data; and
modify the order in which the at least one of the first plurality of coefficients are assigned based on determining how often the position of the at least one of the first plurality of transform coefficients comprises a non-zero coefficient for the plurality of previously decoded blocks of video data.

10. The device of claim 9, wherein the scan module is configured to modify the order in which the at least one of the first plurality of coefficients is scanned based on scanning a first coefficient position of the first plurality of coefficients that comprises a non-zero coefficient more often than a second coefficient position of the first plurality of coefficients, before scanning the second coefficient position.

11. The device of claim 7, wherein the scan module is configured to assign the second plurality of transform coefficients of the one-dimensional vector to positions within the two-dimensional matrix of transform coefficients using the fixed scan based on one or more predetermined scan patterns selected from the group consisting of:
a vertical scan;
a horizontal scan;
a zig-zag scan;
an inverse vertical scan;
an inverse horizontal scan; and
an inverse zig-zag scan.

12. The device of claim 7, wherein the one-dimensional vector includes a third plurality of transform coefficients, and wherein the scan module is further configured to:
not scan the third plurality of transform coefficients.

13. A computer-readable storage medium that stores instructions that, when executed by a computing device, cause the computing device to:
scan a first plurality of transform coefficients of a one-dimensional vector of transform coefficients using an adaptive scan to reconstruct the two-dimensional matrix of transform coefficients from the one-dimensional vector;
scan a second plurality of transform coefficients of the one-dimensional vector using a fixed scan to reconstruct the two-dimensional matrix from the one-dimensional vector; and
decode the two-dimensional matrix of transform coefficients.

14. The computer-readable storage medium of claim 13, wherein the instructions are configured to cause the computing device to:
assign the first plurality of transform coefficients of the one-dimensional vector to positions within the two-dimensional matrix based on modifying an order in which at least one of the first plurality of transform coefficients are assigned relative to a scan order of at least one previously coded block of video data.

15. The computer-readable storage medium of claim 14, wherein the instructions are further configured to cause the computing device to:
determine how often a position of the at least one of the first plurality of transform coefficients comprises a non-zero coefficient for a plurality of previously decoded blocks of video data; and
modify the order in which the at least one of the first plurality of coefficients are assigned based on determining how often the position of the at least one of the first plurality of transform coefficients comprises a non-zero coefficient for the plurality of previously decoded blocks of video data.

16. The computer-readable storage medium of claim 15, wherein the instructions are further configured to cause the computing device to:
modify the order in which the at least one of the first plurality of coefficients is scanned based on scanning a first coefficient position of the first plurality of coefficients that comprises a non-zero coefficient more often than a second coefficient position of the first plurality of coefficients, before scanning the second coefficient position.

17. The computer-readable storage medium of claim 13, wherein the fixed scan comprises using one or more predetermined scan patterns selected from the group consisting of:
a vertical scan;
a horizontal scan;
a zig-zag scan;
an inverse vertical scan;
an inverse horizontal scan; and
an inverse zig-zag scan.

18. The computer-readable storage medium of claim 13, wherein the one-dimensional vector includes a third plurality of transform coefficients, and wherein the instructions are further configured to cause the computing device to:
not scan the third plurality of transform coefficients.

19. A video decoding device, comprising:
means for assigning a first plurality of transform coefficients of a one-dimensional vector of transform coefficients to positions within a two-dimensional matrix of transform coefficients using an adaptive scan to reconstruct the two-dimensional matrix of transform coefficients from the one-dimensional vector;
means for assigning a second plurality of transform coefficients of the one-dimensional vector using a fixed scan to reconstruct the two-dimensional matrix from the one-dimensional vector; and
means for decoding the two-dimensional matrix of transform coefficients.

20. A method for encoding a block of video data, comprising:
scanning a first plurality of transform coefficients of a two-dimensional matrix of transform coefficients using an adaptive scan to generate a one-dimensional vector of transform coefficients;
scanning a second plurality of transform coefficients of the two-dimensional matrix using a fixed scan to generate the one-dimensional vector from the two-dimensional matrix; and
outputting the one-dimensional vector of transform coefficients.

21. The method of claim 20, wherein scanning the first plurality of transform coefficients of the two-dimensional matrix using the adaptive scan comprises modifying an order in which at least one of the first plurality of transform coefficients are scanned relative to a scan of at least one previously coded block of video data.

22. The method of claim 21, further comprising:
determining how often a position of the at least one of the first plurality of transform coefficients comprises a non-zero coefficient for a plurality of previously decoded blocks of video data; and
modifying the order in which the at least one of the first plurality of coefficients are scanned based on determining how often the position of the at least one of the first plurality of transform coefficients comprises a non-zero coefficient for the plurality of previously decoded blocks of video data.

23. The method of claim 22, wherein modifying the order in which the at least one of the first plurality of coefficients is scanned comprises:
scanning a first coefficient of the first plurality of coefficients that comprises a non-zero coefficient more often than a second coefficient of the first plurality of coefficients, before scanning the second coefficient.

24. The method of claim 20, scanning the second plurality of transform coefficients of the two-dimensional matrix using the fixed scan comprises using one or more fixed scans selected from the group consisting of:
a vertical scan;
a horizontal scan;
a zig-zag scan;
an inverse vertical scan;
an inverse horizontal scan; and
an inverse zig-zag scan.

25. The method of claim 20, wherein the two-dimensional matrix includes a third plurality of transform coefficients, and further comprising:
not scanning the third plurality of transform coefficients.

26. A video encoding device, comprising:
a scan module configured to:
scan a first plurality of transform coefficients of a two-dimensional matrix of transform coefficients using an adaptive scan to generate a one-dimensional vector of transform coefficients;
scan a second plurality of transform coefficients of the two-dimensional matrix using a fixed scan to generate the one-dimensional vector from the two-dimensional matrix; and
output the one-dimensional vector of transform coefficients.

27. The device of claim 26, wherein the scan module is configured to scan the first plurality of transform coefficients of the two-dimensional matrix based on modifying an order in which at least one of the first plurality of transform coefficients are scanned relative to a scan of at least one previously coded block of video data.

28. The device of claim 27, wherein the scan module is further configured to:
determine how often a position of the at least one of the first plurality of transform coefficients comprises a non-zero coefficient for a plurality of previously decoded blocks of video data; and
modify the order in which the at least one of the first plurality of coefficients are scanned based on determining how often the position of the at least one of the first plurality of transform coefficients comprises a non-zero coefficient for the plurality of previously decoded blocks of video data.

29. The device of claim 28, wherein the scan module is configured to modify the order in which the at least one of the first plurality of coefficients is scanned based on scanning a first coefficient of the first plurality of coefficients that comprises a non-zero coefficient more often than a second coefficient of the first plurality of coefficients, before scanning the second coefficient.

30. The device of claim 26, wherein the scan module is configured to, for the second plurality of coefficients, use one or more predetermined scan patterns selected from the group consisting of:
a vertical scan;
a horizontal scan;
a zig-zag scan;
an inverse vertical scan;
an inverse horizontal scan; and
an inverse zig-zag scan.

31. The device of claim 26, wherein the two-dimensional matrix includes a third plurality of transform coefficients, and wherein the scan module is further configured to:
not scan the third plurality of transform coefficients.

32. A computer-readable storage medium that stores instructions that, when executed by a computing device, cause the computing device to:
scan a first plurality of transform coefficients of a two-dimensional matrix of transform coefficients using an adaptive scan to generate a one-dimensional vector of transform coefficients;
scan a second plurality of transform coefficients of the two-dimensional matrix using a fixed scan to generate the one-dimensional vector from the two-dimensional matrix; and
output the one-dimensional vector of transform coefficients.

33. The computer-readable storage medium of claim 32, wherein the instructions further cause the computing device to scan the first plurality of transform coefficients of the two-dimensional matrix based on modifying an order in which at least one of the first plurality of transform coefficients are scanned relative to a scan of at least one previously coded block of video data.

34. The computer-readable storage medium of claim 33, wherein the instructions further cause the computing device to:
determine how often a position of the at least one of the first plurality of transform coefficients comprises a non-zero coefficient for a plurality of previously decoded blocks of video data; and
modify the order in which the at least one of the first plurality of coefficients are scanned based on determining how often the position of the at least one of the first plurality of transform coefficients comprises a non-zero coefficient for the plurality of previously decoded blocks of video data.

35. The computer-readable storage medium of claim 34, wherein the instructions further cause the computing device to:
modify the order in which the at least one of the first plurality of coefficients is scanned based on scanning a first coefficient of the first plurality of coefficients that comprises a non-zero coefficient more often than a second coefficient of the first plurality of coefficients, before scanning the second coefficient.

36. The computer-readable storage medium of claim 32, wherein the instructions further cause the computing device to, for the second plurality of coefficients, use one or more predetermined scan patterns selected from the group consisting of:
a vertical scan;
a horizontal scan;
a zig-zag scan;
an inverse vertical scan;
an inverse horizontal scan; and
an inverse zig-zag scan.

37. The computer-readable storage medium of claim 32, wherein the two-dimensional matrix includes a third plurality of transform coefficients, and wherein the instructions further cause the computing device to:
not scan the third plurality of transform coefficients.

38. A video encoding device, comprising:
means for scanning a first plurality of transform coefficients of a two-dimensional matrix of transform coefficients using an adaptive scan to generate a one-dimensional vector of transform coefficients;
means for scanning a second plurality of transform coefficients of the two-dimensional matrix using a fixed scan to generate the one-dimensional vector from the two-dimensional matrix; and
means for outputting the one-dimensional vector of transform coefficients.
